(19) United States
(12) Patent Application Publication
(10) Pub. No.: US 2025/0212227 A1
(43) Pub. Date: Jun. 26, 2025

(54) METHOD, DEVICE AND COMPUTER READABLE MEDIUM OF COMMUNICATION

(71) Applicant: NEC CORPORATION, Tokyo (JP)

(72) Inventors: Peng GUAN, Beijing (CN); Yukai GAO, Beijing (CN); Gang WANG, Beijing (CN)

(73) Assignee: NEC CORPORATION, Tokyo (JP)

(21) Appl. No.: 18/847,440

(22) PCT Filed: Mar. 17, 2022
(86) PCT No.: PCT/CN2022/081546

§ 371 Date: Sep. 16, 2024

(51) Int. Cl. H04W 72/231; H04L 5/00; H04W 72/1268; H04W 76/20

(52) U.S. Cl. CPC H04W 72/231; H04L 5/0051; H04W 72/1268; H04W 76/20

(57) ABSTRACT

Embodiments of the present disclosure relate to method, device and computer readable medium of communication. A terminal device deployed with first and second sets of antenna ports receives DCI for scheduling an uplink transmission, the DCI comprising a first SRI and a second SRI. The terminal device determines a first set of antenna port indexes based on a first number of layers of the uplink transmission indicated by the first SRI and indexes of SRS resources in a first set of SRS resources, and determines a second set of antenna port indexes based on indexes of SRS resources in a second set of SRS resources, a second number of layers of the uplink transmission indicated by the second SRI and the number of SRS resources in the first set of SRS resources. Then the terminal device performs the uplink transmission over antenna ports corresponding to the first and second sets of antenna port indexes. In this way, a simultaneous transmission across multi-panels is well supported.

### TECHNICAL FIELD

Example embodiments of the present disclosure generally relate to the field of telecommunication and in particular, to methods, devices, and computer readable media of communication for simultaneous transmission across multi-panels (STxMP).

### BACKGROUND

A non-codebook-based (NCB-based) physical uplink shared channel (PUSCH) transmission is an uplink transmission scheme exploiting downlink (DL)-uplink (UL) channel reciprocity. For the NCB-based PUSCH transmission, a network device may transmit a channel state information-reference signal (CSI-RS) or indicate an UL beam to a terminal device, and the terminal device may determine an UL precoder based on a measurement on the CSI-RS or the indicated UL beam, without a predefined precoding matrix.

Currently, it has been proposed that a terminal device may be deployed with multiple panels. As a traditional assumption, the terminal device can transmit with only one panel at a time even if the terminal device is equipped with multiple panels. To improve transmission performance, a technology of STxMP is expected to be supported. Although some discussions for the STxMP have been made, there are still some pending issues needed to be discussed, such that a NCB-based PUSCH STxMP may be better supported.

### SUMMARY

In general, example embodiments of the present disclosure provide methods, devices and computer storage media of communication for STxMP.

In a first aspect, there is provided a method of communication. The method comprises: receiving, at a terminal device deployed with first and second sets of antenna ports, downlink control information (DCI) for scheduling an uplink transmission, the DCI comprising a first sounding reference signal (SRS) resource indicator and a second SRS resource indicator; determining a first set of antenna port indexes based on a first number of layers of the uplink transmission and indexes of SRS resources in a first set of SRS resources, the first number of layers being indicated by the first SRS resource indicator and being transmitted over the first set of antenna ports; determining a second set of antenna port indexes based on indexes of SRS resources in a second set of SRS resources, a second number of layers of the uplink transmission and the number of SRS resources in the first set of SRS resources, the second number of layers being indicated by the second SRS resource indicator and being transmitted over the second set of antenna ports; and performing the uplink transmission over antenna ports corresponding to the first and second sets of antenna port indexes in the first and second sets of antenna ports.

In a second aspect, there is provided a method of communication. The method comprises: receiving, at a terminal device deployed with first and second sets of antenna ports, DCI for scheduling an uplink transmission, the DCI comprising a SRS resource indicator; determining a set of antenna port indexes based on a number of layers of the uplink transmission, indexes of SRS resources in a first set of SRS resources and the number of SRS resources in the first set of SRS resources, the number of layers being indicated by the SRS resource indicator and being transmitted over each of the first and second sets of antenna ports; and performing the uplink transmission over a set of antenna ports corresponding to the set of antenna port indexes in the first and second sets of antenna ports.

In a third aspect, there is provided a method of communication. The method comprises: determining, at a terminal device, a default capability value set, the default capability value set being associated with a bandwidth part (BWP) configured for the terminal device; and performing at least one of the following: performing an initial transmission with a network device by applying the default capability value set; or in accordance with a determination that a fallback condition is satisfied, performing an uplink transmission by applying the default capability value set.

In a fourth aspect, there is provided a method of communication. The method comprises: transmitting, at a network device and to a terminal device deployed with first and second sets of antenna ports, DCI for scheduling an uplink transmission, the DCI comprising a first SRS resource indicator and a second SRS resource indicator; determining a first set of antenna port indexes based on a first number of layers of the uplink transmission and indexes of SRS resources in a first set of SRS resources, the first number of layers being indicated by the first SRS resource indicator and being transmitted over the first set of antenna ports; determining a second set of antenna port indexes based on indexes of SRS resources in a second set of SRS resources, a second number of layers of the uplink transmission and the number of SRS resources in the first set of SRS resources, the second number of layers being indicated by the second SRS resource indicator and being transmitted over the second set of antenna ports; and performing the uplink transmission over antenna ports corresponding to the first and second sets of antenna port indexes in the first and second sets of antenna ports.

In a fifth aspect, there is provided a method of communication. The method comprises: transmitting, at a network device and to a terminal device deployed with first and second sets of antenna ports, DCI for scheduling an uplink transmission, the DCI comprising a SRS resource indicator; determining a set of antenna port indexes based on a number of layers of the uplink transmission, indexes of SRS resources in a first set of SRS resources and the number of SRS resources in the first set of SRS resources, the number of layers being indicated by the SRS resource indicator and being transmitted over each of the first and second sets of antenna ports; and performing the uplink transmission over a set of antenna ports corresponding to the set of antenna port indexes in the first and second sets of antenna ports.

In a sixth aspect, there is provided a method of communication. The method comprises: determining, at a network device, a default capability value set for a terminal device, the default capability value set being associated with a BWP configured for the terminal device; and performing at least one of the following: performing an initial transmission with the terminal device by applying the default capability value set; or in accordance with a determination that a fallback condition is satisfied, performing an uplink transmission by applying the default capability value set.

In a seventh aspect, there is provided a terminal device. The terminal device comprises a processor configured to cause the terminal device to perform the method according to any of the first to third aspects of the present disclosure.

In an eighth aspect, there is provided a network device. The network device comprises a processor configured to cause the network device to perform the method according to any of the fourth to sixth aspects of the present disclosure.

In a ninth aspect, there is provided a computer readable medium having instructions stored thereon. The instructions, when executed on at least one processor, causing the at least one processor to perform the method according to any of the first to sixth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which embodiments of the present disclosure can be implemented;

FIG. 1B illustrates another example communication network in which embodiments of the present disclosure can be implemented;

FIG. 1C illustrates still another example communication network in which embodiments of the present disclosure can be implemented;

FIG. 2A illustrates a signaling flow for scheduling a NCB-based PUSCH transmission in which embodiments of the present disclosure can be implemented;

FIG. 2B illustrates examples of coherent types;

FIG. 2C illustrates examples of full power modes;

FIG. 3A illustrates an example of a transmission mode of STxMP in which embodiments of the present disclosure can be implemented;

FIG. 3B illustrates an example of a transmission mode of STxMP in which embodiments of the present disclosure can be implemented;

FIG. 3C illustrates an example of a transmission mode of STxMP in which embodiments of the present disclosure can be implemented;

FIG. 4A illustrates an example of an antenna structure corresponding to a hybrid beamforming type;

FIG. 4B illustrates an example of an antenna structure corresponding to a hybrid beamforming type;

FIG. 4C illustrates an example of an antenna structure corresponding to a hybrid beamforming type;

FIG. 4D illustrates an example of an antenna structure corresponding to a hybrid beamforming type;

FIG. 5 illustrates a schematic diagram illustrating a process of communication according to some example embodiments of the present disclosure;

FIG. 6 illustrates a schematic diagram illustrating another process of communication according to some example embodiments of the present disclosure;

FIG. 7 illustrates a schematic diagram illustrating still another process of communication according to some example embodiments of the present disclosure;

FIG. 8 illustrates a flowchart of an example method performed by a terminal device in accordance with some embodiments of the present disclosure;

FIG. 9 illustrates a flowchart of an example method performed by a terminal device in accordance with some embodiments of the present disclosure;

FIG. 10 illustrates a flowchart of an example method performed by a terminal device in accordance with some embodiments of the present disclosure;

FIG. 11 illustrates a flowchart of an example method performed by a network device in accordance with some embodiments of the present disclosure;

FIG. 12 illustrates a flowchart of an example method performed by a network device in accordance with some embodiments of the present disclosure;

FIG. 13 illustrates a flowchart of an example method performed by a network device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As mentioned above, there are still some pending issues needed to be discussed, such that a NCB-based PUSCH STxMP may be better supported. For example, a configuration of SRS resources or SRS resource sets, a reporting of a capability of a terminal device, an indication of SRS resource indicator (SRI) and so on are needed to be further developed for the NCB-based PUSCH STxMP.

In view of this, embodiments of the present disclosure provide solutions of communication for STxMP so as to overcome the above or other potential issues. In one aspect, two SRS resource sets are applied jointly for STxMP and two SRS resource indicators are provided in single DCI. In another aspect, one dedicated SRS resource set is applied for STxMP and one SRS resource indicator is provided in single DCI. In still another aspect, a default panel associated with a BWP is proposed. In this way, a PUSCH STxMP may be better supported.

Principles and implementations of the present disclosure will be described in detail below with reference to the figures.

In the present disclosure, some terms may refer to same or similar physical meaning and may be used interchangeably. Some exemplary examples are listed as below.
The terms “port(s) used for a uplink transmission”, “port(s) used for a PUSCH transmission”, “port(s) with non-zero PUSCH transmission power” and “port(s) with non-zero uplink transmission power” can be used interchangeably;
The terms “panel(s) used for a uplink transmission”, “panel(s) used for a PUSCH transmission”, “panel(s) with non-zero PUSCH transmission power” and “panel(s) with non-zero uplink transmission power” can be used interchangeably;
The terms “transmission capability information”, “UE capability information”, “capability-related information”, “capability value set”, “panel information” and “panel-related information” can be used interchangeably;
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;
The terms “single TRP”, “single TCI state”, “single TCI”, “S-TCI”, “single CORESET”, “single control resource set pool”, “S-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably;
The terms “resource(s)”, “resource(s) in a resource set”, “resource set” can be used interchangeably; and
The terms “group”, “subset”, “set” can be used interchangeably.
Further, one panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” can be used interchangeably.
In addition, panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID.
As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.
As used herein, the term “SRS transmission” refers to a transmission of SRS resource identified by SRS signal resource indicator (SRI) in a DCI message for uplink grant. Accordingly, term “the latest SRS transmission” refers to the latest transmission of SRS resource identified by SRI in a DCI message for uplink grant.
As used herein, the term “network”/“network device(s)” refer to one or more network devices. Accordingly, terms “network”, “network device(s)” and “one or more network devices” can be used interchangeably.
‘Panel with lower capability’ can be used interchangeably with ‘panel with higher capability’, ‘panel corresponds to lower/higher capability value set index’, ‘panel used most recently’, ‘[old] panel used in initial access/least PRACH’ and so on. In other words, it can be any pre-defined rule known at both NW and UE side, or signaled by NW/UE to each other by configuration/capability reporting/request.
“BWP ID/index” can be used interchangeably with “BWP/CC ID/index”, “CC identity/index”, “cell identity/index” “, “physical cell identity/index” and “serving cell identity/index”.

### Example of Communication Environment

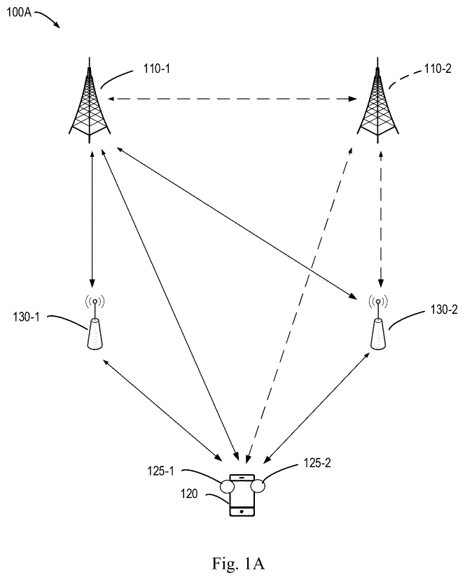

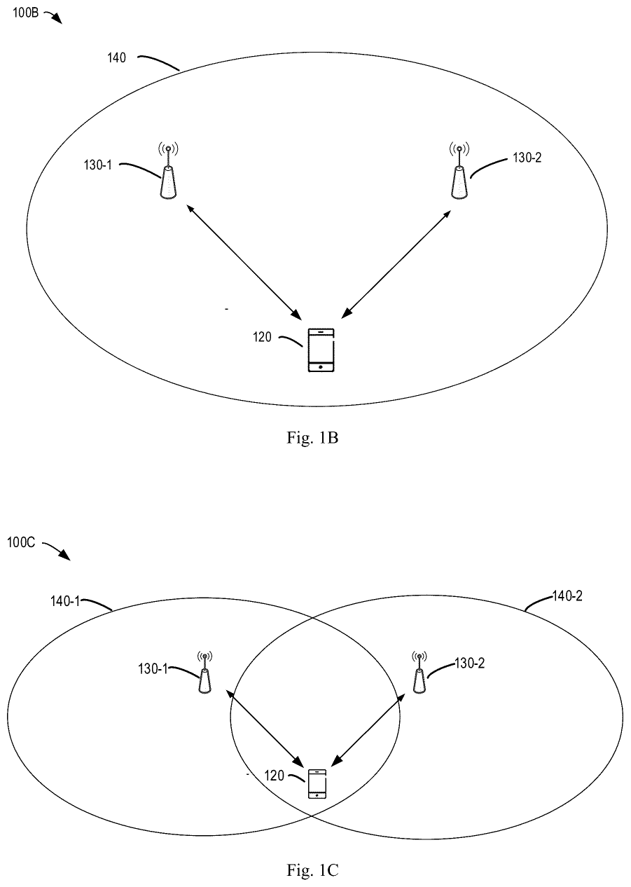

FIG. 1A illustrates an example communication network 100A in which embodiments of the present disclosure can be implemented. The communication network 100A includes a network device 110-1 and an optionally network device 110-2 (collectively or individually referred to as network devices 110). The network device 110 can provide services to a terminal device 120. For purpose of discussion, the network device 110-1 is referred to as the first network device 110-1, and the network device 110-2 is referred to as the second network device 110-2. Further, the first network device 110-1 and the second network device 110-1 can communicate with each other.

In the communication network 100A, a link from the network devices 110 (such as, a first network device 110-1 or the second network device 110-2) to the terminal device 120 is referred to as a downlink, while a link from the terminal device 120 to the network devices 110 (such as, a first network device 110-1 or the second network device 110-2) is referred to as an uplink. In downlink, the first network device 110-1 or the second network device 120-1 is a transmitting (Tx) device (or a transmitter) and the terminal device 120 is a receiving (Rx) device (or a receiver). In uplink, the terminal device 120 is a transmitting Tx device (or a transmitter) and the first network device 110-1 or the second network device 110-2 is a Rx device (or a receiver).

In some embodiments, the network device(s) 110 and the terminal device 120 may communicate with direct links/channels.

In addition, the terminal device 120 may be deployed with more than one panel. As illustrated in FIG. 1A, the terminal device 120 is deployed with panels 125-1 and 125-2. In the following, the panels 125-1 and 125-2 may be referred to as the first panel 125-1 and the second panel 125-2, respectively.

In some embodiments, the first panel 125-1 and the second panel 125-2 correspond to different sets of antenna port(s)/antenna element(s)/antenna array(s). As one specific example, the first panel 125-1 corresponds to a first set of antenna ports and the second panel 125-2 corresponds to a second set of antenna ports. In some embodiments, the panels 125-1 and 125-2 may correspond to different capability value sets, respectively.

In the communication network 100A, a NCB-based PUSCH STxMP is supported.

Specifically, the terminal device 120 may perform a NCB-based PUSCH over both of the panels 125-1 and 125-2 simultaneously.

Further, in the specific example of FIG. 1A, a multi-TRP transmission also is supported. As illustrated in FIG. 1A, the terminal device 120 may communicate with two TRPs, i.e., the TRPs 130-1 and 130-2 (collectively or individually referred to as TRP 130). For purpose of discussion, the TRP 130-1 is referred to as the first TRP 130-1, and the TRP 130-2 is referred to as the second TRP 130-2.

In addition, in order to support multi-TRP and/or multi-panel, the network device 110 may be equipped with one or more TRPs. For example, the network device 110 may be coupled with multiple TRPs in different geographical locations to achieve better coverage. In one specific example embodiment, the first network device 110-1 is equipped with the first TRP 130-1 and the second TRP 130-2. Alternatively, in another specific example embodiment, the first network device 110-1 and the second network device 110-2 are equipped with the first TRP 130-1 and the second 130-2, respectively.

In some embodiments, the first TRP 130-1 and the second TRP 130-2 are associated with different control resource set pools (CORESET pools). For example, the first TRP 130-1 is associated with a first control resource set pool while the second TRP 130-2 is associated with a second control resource set pool.

Further, both a single TRP mode transmission and multi-TRP transmission are supported by the specific example of FIG. 1A. Specifically, in case of the single TRP mode, the terminal device 120 communicates with the network via the first TRP 130-1/second TRP 130-2. Alternatively, in case of the multi-TRP mode, the terminal device 120 communicates with the network via both of the first TRP 130-1 and the second TRP 130-2.

As one specific example embodiment, during a NCB-based PUSCH STxMP, the terminal device 120 communicates with the first TRP 130-1 via panel 125-1 and communicates with the second TRP 130-2 via panel 125-2 simultaneously.

Further, the network device(s) 110 may provide one or more serving cells and the first TRP 130-1 and the second TRP 130-2 may be included in a same serving cell or different serving cells. In other words, both an inter-cell transmission and an intra-cell transmission are supported by the specific example of FIG. 1A.

FIG. 1B shows an example scenario of the communication network 100A as shown in FIG. 1A. In the specific example of FIG. 1B, the first TRP 130-1 and the second TRP 130-2 are included in a same serving cell 140. In this event, the multi-TRP transmission is performed as an intra-cell transmission.

FIG. 1C shows another example scenario of the communication network 100A as shown in FIG. 1A. In the specific example of FIG. 1C, the first TRP 130-1 and the second TRP 130-2 are included in different serving cells 140-1 and 140-2. In this event, the multi-TRP transmission is performed as an inter-cell transmission.

The communications in the communication network 100A may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of elements (i.e., the terminal device 120, the panel 125, the network device 110, the TRP 130 and the cell 140) and their connection relationships and types shown in FIGS. 1A to 1C are only for purpose of illustration without suggesting any limitation. The communication network 100A may include any suitable numbers of elements adapted for implementing embodiments of the present disclosure.

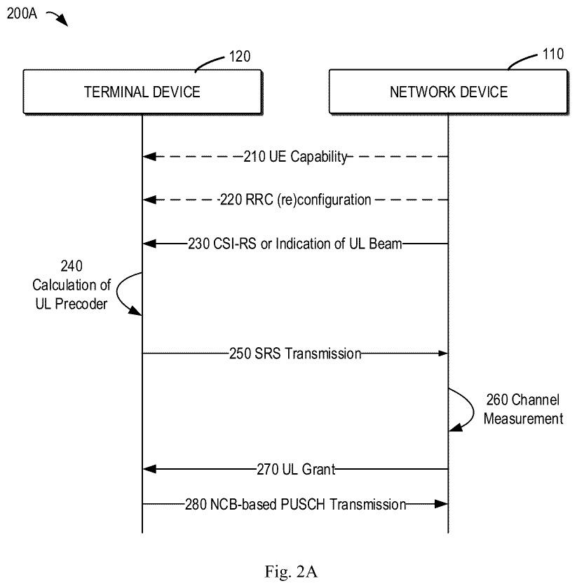

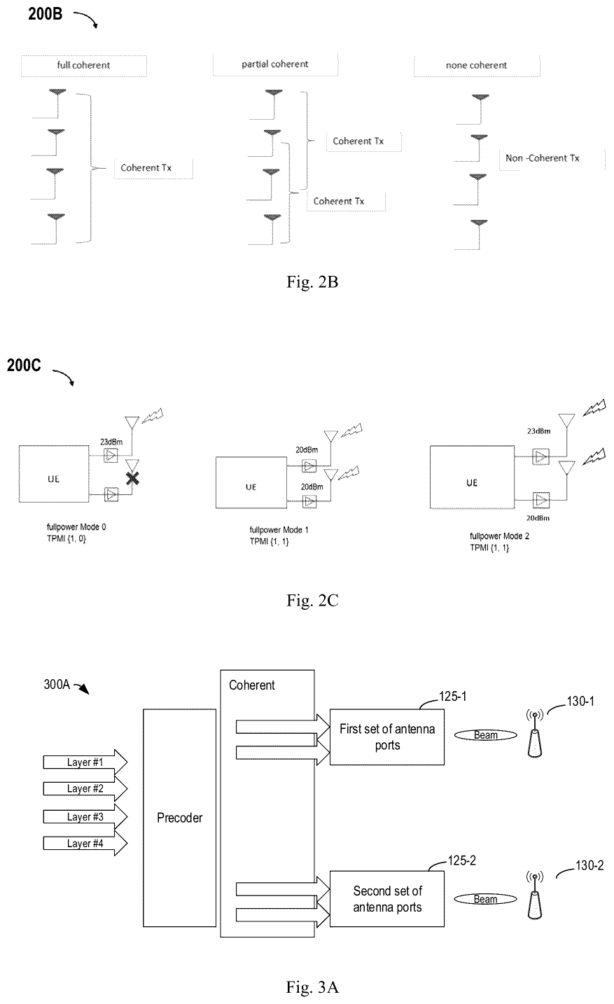

FIG. 2A illustrates a signaling flow 200A for scheduling a NCB-based PUSCH transmission in which embodiments of the present disclosure can be implemented. As illustrated in FIG. 2A, the terminal device 120 may transfer 210 information of UE capability to the network device 110.

One example of the UE capability is coherent type(s) supported by the terminal device 120, where the coherent type may be one of full coherent (fullCoherent), partial coherent (partialCoherent) and Non-coherent (nonCoherent). In one specific example embodiment, the coherent type(s) may be reported by using an information element (IE) pusch-TransCoherence. FIG. 2B illustrates examples 200B of coherent types. In addition, only a subset of precoders may be used for a certain coherence type.

Another example of the UE capability is full power mode(s) supported by the terminal device, where the full power mode may be one of fullpower mode 0 (fullpower or ul-FullPwrMode), fullpower mode 1 (ul-FullPwrMode1 or fullpowerMode1) and fullpower mode 2 (ul-FullPwrMode2 or fullpowerMode2). FIG. 2C illustrates examples 200C of full power modes. Specifically, in case of fullpower mode 0, transmit power is equally split among non-zero PUSCH antenna(s) thereby enabling the terminal device to deliver the maximum output power of 23 dBm. In case of fullpower mode 1, the terminal device 110 may transmit with the total maximum output power of 23 dBm on PUSCH with precoder {1, 1}, which means that the precoders {1, 0} and {0, 1} cannot deliver the maximum output power. In case of fullpower mode 2, the terminal device 110 may transmit with the total maximum output power of 23 dBm on PUSCH with precoder {1, 1} through procedures of the precoder reporting and antenna virtualization.

Further, the full power mode(s) may be reported with an information element (IE), including but not limited to, the followings: ul-FullPwrMode-r16, ul-FullPwrMode2-MaxSRS-ResInSet-r16, ul-FullPwrMode1-r16 and so on. In addition, only a subset of precoders may be used for a certain full power capability.

The other UE capabilities may be the maximum number of UL layers supported by the terminal device 120 and the maximum number of SRS ports supported by the terminal device 120.

Continue to refer to FIG. 2A, the network device 110 may transmit 220 a radio resource control (RRC) (re) configuration message to configure a NCB-based PUSCH. For example, information configured by the RRC (re) configuration message may comprise a SRS configuration and a PUSCH configuration.

The network device 110 may transmit 230, to the terminal device 120, CSI-RS(s) for SRS transmission or an indication of UL beam(s) for SRS transmission. The terminal device may calculate 240 UL precoder(s) based on a measurement on the CSI-RS(s) or based on the indicated UL beam(s).

Then the terminal device 120 may transmit 250, to the network device 110, SRS(s) precoded based on the calculated UL precoder(s). Accordingly, the network device may perform 260 channel measurements by measuring the SRS(s). In this way, the network device may determine PUSCH layer(s) and precoder(s).

After the above procedure, the network device 110 may transmit 270 an UL grant (e.g., DCI format 0_1, 0_2, or a PUSCH configuration within parameters for configured grant PUSCH transmission) to schedule a NCB-based PUSCH transmission. Based on the received UL grant, the terminal device 120 may perform 280 the NCB-based PUSCH transmission to the network device 110.

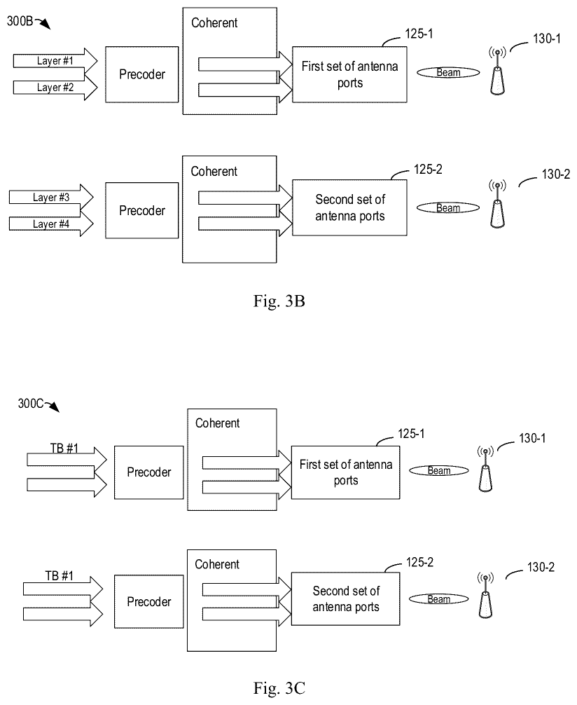

FIG. 3A illustrates an example 300A of a transmission mode of STxMP in which embodiments of the present disclosure can be implemented. In this example, the transmission mode is a coherent joint transmission (CJT) with multiple activated panels/sets of antenna ports. As illustrated in FIG. 3A, all the antenna ports may be used jointly regardless whether the antenna ports are comprised in the first panel 125-1 or the second panel 125-2.

FIG. 3B illustrates an example 300B of a transmission mode of STxMP in which embodiments of the present disclosure can be implemented. In this example, the transmission mode is a non-coherent joint transmission (NCJT) with multiple activated panels/sets of antenna ports. As illustrated in FIG. 3B, the first panel 125-1 and the second panel 125-2 are non-coherent, while the antenna ports within a same panel are coherent. In the specific example of FIG. 3B, both of one-codeword (CW) or two-CWs transmission are supported. In some embodiments, the mapping of CW-to-layer allows that the two-CWs transmissions is transmitted with more than 4 layers, while two CWs can be supported by transmitting one TB per panel/TRP and each of the two CWs can be mapped to layers #1˜#4. In the specific example of FIG. 3B, one codeword (CW) i.e., one TB, is divided into four layers (layers #1˜#4).

In some embodiments, different layers may be transmitted by different panels simultaneously. Specifically, layers (0, . . . , v1−1) are transmitted by the first panel 125-1 and layers (v1, . . . , v−1) are transmitted by the second panel 125-2, where v1 is the number of layers transmitted via the first panel 125-1, and v is the total number of layers of the CW via both the first and second panels 125. As illustrated in FIG. 3B, the layers #1 and #2 are transmitted via the first panel 125-1 while the layers #3 and #4 are transmitted via the second panel 125-2.

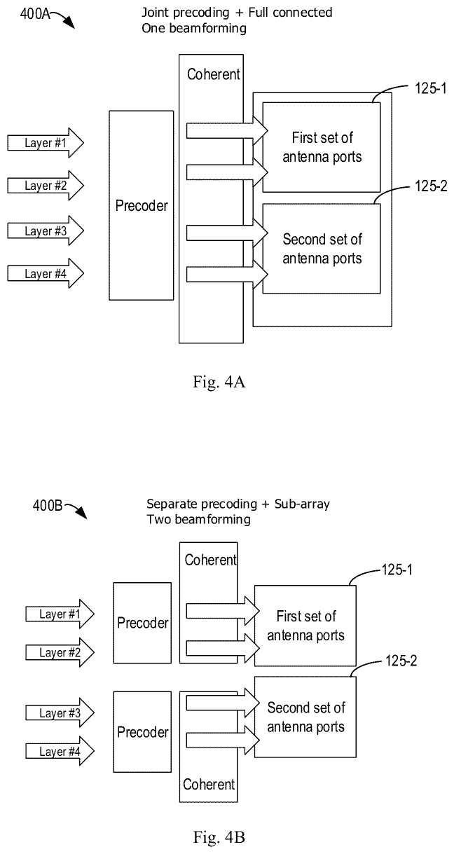

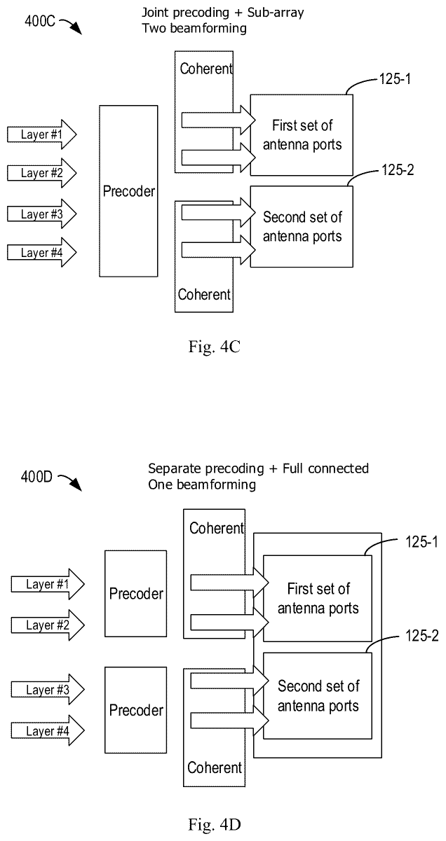

In some embodiments, different precoding matrices (i.e., precoders) may be used by different panels. Specifically, a first precoding matrix is used by the first panel 125-1 and the second precoding matrix is used by the second panel 125-2. As illustrated in FIG. 4B, the precoding matrix #1/precoder #1 is used by the first panel 125-1 while the precoding matrix #2/precoder #2 is used by the second panel 125-2.

In some embodiments, different beamforming are used by different panels. As a result, a first beam may be formed by the first panel 125-1 and pointed to the first TRP 130-1, a second beam may be formed by the second panel 125-2 and pointed to the second TRP 130-2. In this way, the first and second TRPs 130 may process the uplink transmission (such as, a NCB-based PUSCH STxMP) received PUSCH jointly.

It should be understood that as a general rule, the non-coherent joint transmission may be performed among different panels/ports/beams/layers to different TRPs.

FIG. 3C illustrates an example 300C of a transmission mode of STxMP in which embodiments of the present disclosure can be implemented. In this example, the transmission mode is a same transport block (TB) space division multiplexing (SDM) repetition (referred to as SDM repetition for brevity) PUSCH per panels/sets of antenna ports, or, to different TRPs. As illustrated in FIG. 3C, the first panel 125-1 and the second panel 125-2 are non-coherent, while the antenna ports within a same panel are coherent.

In some embodiments, a same TB is transmitted to different multiple TRPs simultaneously via different panels. Specifically, a same number of layers is assumed for different panels. Specifically, layers (0, . . . , v) are transmitted by the first panel 125-1 and the second panel 125-2, where v is the total number of layers of the CW via both the first and second panels 125.

In some embodiments, different precoding matrices (i.e., precoders) may be used by different panels. Specifically, a first precoding matrix is used by the first panel 125-1 and the second precoding matrix is used by the second panel 125-2. As illustrated in FIG. 3C, the precoding matrix #1/precoder #1 is used by the first panel 125-1 while the precoding matrix #2/precoder #2 is used by the second panel 125-2.

In some embodiments, different beamforming are used by different panels. As a result, a first beam may be formed by the first panel 125-1 and pointed to the first TRP 130-1, a second beam may be formed by the second panel 125-2 and pointed to the second TRP 130-2. In this way, the first and second TRPs 130 may process the uplink transmission (such as, a NCB-based PUSCH STxMP) received PUSCH jointly (by soft combining) or separately.

In some embodiment, the communication network 100A may support a hybrid beamforming type associated with a digital precoding manner and an analog beamforming manner. In some embodiments, the digital precoding manner may be one of the following: joint precoding across panels/for multiple TRPs; or separate precoding per panel/for each TRP (e.g., different layers/TB per panel/TRP). In some embodiments, the analog beamforming manner may be one of the following: full connected; or sub-array connection.

For the full connected manner, one antenna port is connected with all antenna elements. For example, the same beam is formed by multiple panels/towards different TRPs. For the sub-array connection manner, one antenna port is connected with a subset of antenna elements. For example, different beams are formed by one panel/towards different TRPs.

In some embodiments, a first coherence type indicates a panel-level coherence capability, a second coherence type indicates a port-level coherence capability within a panel, a first full power mode indicates a panel-level full power capability, or a second full power mode indicates a port-level full power capability within a panel.

In some embodiments, the first full power mode is one of the following:
a first panel-level full power mode indicating that a full power is achieved regardless of a number of panels used for the uplink transmission; That is, a panel-level full power mode is supported, and the terminal device 120 can deliver with the maximum output even a subset of panels are used for transmission, which can be considered as per UE power constraint;
a second panel-level full power mode indicating that the full power is enabled to be delivered when all panels of the terminal device 120 are used for the uplink transmission; That is, a panel-level full power mode 1 is supported, and the terminal device 120 can only transmit with the maximum output when all panels are used for transmission; or
a third panel-level full power mode indicating that the full power is enabled when all panels of the terminal device 120 are used for the uplink transmission or at least one specific precoder or precoder combination is configured; That is, a panel-level full power mode 2 is supported, and the terminal device 120 can only transmit with the maximum output when all panels are used for transmission, or the terminal device 120 can only transmit with the maximum output when the reported precoder/precoder combination is indicated.

Additionally, in some embodiments, if the first full power mode is the third panel-level full power mode, the transmission capability information further comprises information about the at least one specific precoder or precoder combination.

In addition, the coherence type (including the first and second coherence types) and full power mode (including the first and second full power modes) depend on either or both of the supported STxMP mode (i.e., the transmission mode) and UE hybrid beamforming type (i.e., the hybrid beamforming type). Specifically, in some embodiments, the first coherence type, the second coherence type, the first full power mode and the second full power mode are associated with the transmission mode. Alternatively, or in addition, in some other embodiments, the first coherence type, the second coherence type, the first full power mode and the second full power mode are associated with the hybrid beamforming type associated with a digital precoding manner and an analog beamforming manner. Such association(s) will be discussed with reference to FIGS. 4A to 4D.

FIG. 4A illustrates an example 400A of an antenna structure corresponding to a hybrid beamforming type. In this example, a combination of joint precoding and full connected is supported. In the specific example of FIG. 4A, the coherent type is full coherent and both the first and the second can be full power mode 0, full power mode 1, or full power mode 2. Such antenna structure is especially suitable for an uplink CJT (such as, a coherent STxMP PUSCH transmission).

FIG. 4B illustrates an example 400B of an antenna structure corresponding to a hybrid beamforming type. In this example, a combination of separate precoding and sub-array (i.e., separated digital precoding and sub-array connection analog beamforming) is supported. In the specific example of FIG. 4B, the transmission mode is NCJT (such as, a non-coherent STxMP PUSCH transmission), and the coherent type is partial coherent (i.e., full coherent within the first/second panel and non-coherent across the first panel 130-1 and the second panel 130-2). Further, in the specific example of FIG. 4B, the first full power mode is full power mode 1 or 2 (i.e., full power mode 1 or 2 across the first panel 130-1 and the second panel 130-2) and the second full power mode is full power mode 0 (i.e., full power mode 0 within the first/second panel). Such antenna structure is especially suitable for an uplink NCJT, or an uplink simultaneous SDM repetition where the same TB is replaced with a subset of layers.

FIG. 4C illustrates an example 400C of an antenna structure corresponding to a hybrid beamforming type. In this example, a combination of joint precoding and sub-array (i.e., joint precoding and sub-array connection analog beamforming) is supported. In the specific example of FIG. 4C, the coherent type is partial coherent (i.e., full coherent within the first/second panel and non-coherent across the first panel 130-1 and the second panel 130-2). Further, in the specific example of FIG. 4C, the first full power mode is full power mode 1 or 2 (i.e., full power mode 1 or 2 across the first panel 130-1 and the second panel 130-2) and the second full power mode is full power mode 0 (i.e., full power mode 0 within the first/second panel). Such antenna structure especially is suitable for an uplink simultaneous SDM repetition.

FIG. 4D illustrates an example 400D of an antenna structure corresponding to a hybrid beamforming type. In this example, a combination of separate precoding and full connected (i.e., separate precoding and full connection analog beamforming) is supported. In the specific example of FIG. 4D, the coherent type is full coherent and both the first and the second can be full power mode 0, full power mode 1, or full power mode 2.

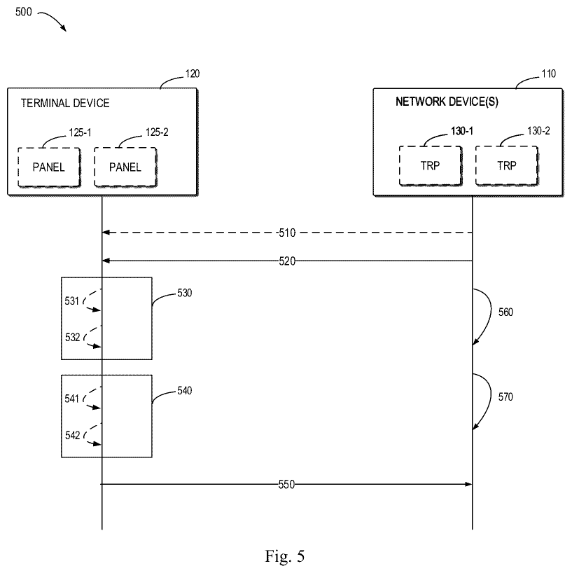

To better support a NCB-based PUSCH STxMP, there are still some pending issues on a configuration of SRS resources or SRS resource sets for the NCB-based PUSCH STxMP, a reporting of UE capability for the NCB-based PUSCH STxMP, an indication of SRI for a NCB-based PUSCH STxMP and so on. Embodiments of the present disclosure provide solutions of communication for STxMP so as to overcome the above or other potential issues. These solutions will be described below with reference to FIGS. 5 to 7.

FIGS. 5 to 7 illustrate schematic diagrams illustrating processes of communication according to some example embodiments of the present disclosure. For the purpose of discussion, the processes will be described with reference to FIGS. 1A to 1C.

Each of the processes may involve the terminal device 120, the network device 110 (either or both of the first network device 110-1 and the second network device 110-2), and optionally may involve the TRPs 130 (including the first TRP 130-1 and the second TRP 130-2). In other words, the implementations of some embodiments do not depend on the TRPs 130. The terminal device 120 may be deployed with the first panel 125-1 and the second panel 125-2. Further, the first panel 125-1 corresponds to a first set of antenna ports and the second panel 125-2 corresponds to a second set of antenna ports.

Additionally, the first TRP 130-1 is connected to the first network device 110-1, while the second TRP 130-2 is connected to the first network device 110-1/second network device 110-2. In addition, the first TRP 130-1 and the second TRP may be in a same serving cell and in different serving cells.

In the following text, although some embodiments of the present disclosure are described with reference to two TRPs and two panels, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Further, it is to be understood that the operations at the terminal device 120 and the network device 110 should be coordinated. In other words, the network device 110 and the terminal device 120 should have common understanding about configuration, parameter and so on. Such common understanding may be implemented by any suitable interactions between the network device 110 and the terminal device 120 or both the network device 110 and the terminal device 120 applying the same rule/policy. In the following, although some operations are described from a perspective of the terminal device 120, it is to be understood that the corresponding operations should be performed by the network device 110. Similarly, although some operations are described from a perspective of the network device 110, it is to be understood that the corresponding operations should be performed by the terminal device 120. Merely for brevity, some of the same or similar contents are omitted here.

In addition, in the following description, some interactions are performed among the terminal device 120 and the network device 110 (such as, exchanging capability-related information, configuring/scheduling/activating resource/transmission and so on). It is to be understood that the interactions may be implemented either in one single signaling/message or multiple signaling/messages, including system information, a radio resource control (RRC) message, DCI, uplink control information (UCI), a medium access control (MAC) control element (CE) and so on. The present disclosure is not limited in this regard.

In some embodiments, the one or more interaction may be specific to a particular panel, a TRP, a capability value, a control resource set (CORESET) and so on. In this way, the PUSCH STxMP may be configured/activated flexibly.

Moreover, it should be understood that although feature(s)/operation(s) are discussed in specific example embodiments separately, unless clearly indicated to the contrary, these feature(s)/operation(s) described in different example embodiments may be used in any suitable combination.

Example Implementation of STxMP with Two SRS Resource Sets

In this embodiment, two SRS resource sets are applied jointly for STxMP and two SRS resource indicators are provided in single DCI.

FIG. 5 illustrates a schematic diagram illustrating a process 500 of communication according to some example embodiments of the present disclosure. For the purpose of discussion, the process 500 will be described with reference to FIGS. 1A to 1C.

### 1. SRS Configuration

As shown in FIG. 5, the network device 110 may transmit 510, to the terminal device 120, a SRS configuration indicating a first set of SRS resources and a second set of SRS resources. Accordingly, the terminal device 120 may receive the SRS configuration. For example, the first and second sets of SRS resources may be configured with parameter “usage” set to “noncodebook”. Assuming that 1-port SRS resource is set for the first and second sets of SRS resources. It is to be understood that the number of the first and second sets of SRS resources is not limited to one, and any other suitable number is also feasible.

In some embodiments, SRS resources in the first and second sets of SRS resources are allowed to be used for simultaneous transmission. In some example embodiments, SRS resources in the same set may be transmitted simultaneously. For example, SRS resources in the same set may be only transmitted via the same UL beam. As another example, the number of SRS resources in the same set may be smaller than or equal to a number indicated in UE capability corresponding to the set. The number indicated in the UE capability may comprise UE reported per-panel or single-panel values for at least one of the following capability: maxNumberSRS-Ports, maxNumberMIMO-LayersNonCB-PUSCH, maxNumberSimultaneousSRS-ResourceTx, maxNumberSRS-ResourcePerSet. It is to be understood that any other suitable forms of capability are also feasible.

In some example embodiments, SRS resources in different sets may be transmitted simultaneously. For example, SRS resources in different sets may be transmitted via different UL beams. As another example, the total number of SRS resources in both of the first and second sets may be smaller than or equal to the number indicated in UE capability corresponding to the first and second sets. The number indicated in the UE capability may comprise UE reported in-total values or STxMP values for at least one of the following capability: maxNumberSRS-Ports, maxNumberMIMO-LayersNonCB-PUSCH, maxNumberSimultaneousSRS-ResourceTx, maxNumberSRS-ResourcePerSet. It is to be understood that any other suitable forms of capability are also feasible.

In some embodiments, the first and second sets of SRS resources are configured with the same time-domain configuration. In other words, both of the first and second sets are configured with the same time-domain behavior. In this way, the SRS configuration may be used to set all SRS resources to be transmitted at the same symbol.

For example, both of the first and second sets may be configured as “periodic”. As another example, both of the first and second sets may be configured as “semi-persistent”. As still another example, both of the first and second sets may be configured as “aperiodic”.

In some embodiments where both of the first and second sets may be configured with aperiodic, both of the first and second sets may be configured with the same trigger value or entry in an aperiodic SRS trigger list. For example, aperiodicSRS-ResourceTrigger or the value of an entry in AperiodicSRS-ResourceTriggerList in each SRS-ResourceSet is the same. In some embodiments where both of the first and second sets may be configured as “periodic” or “semi-persistent”, both of the first and second sets may be configured with the same periodicity and/or offset.

In some embodiments, the first and second sets of SRS resources are configured with the same UL beam configuration. In other words, both of the first and second sets are configured with the same UL beam configuration. In this way, the SRS configuration may be used to set all SRS resources to be transmitted at the same symbol. In other words, both of the first and second sets may be configured with the same value for the parameter ‘useIndicatedTCIState’. In some example embodiments, the indicated TCI state may contain at least two UL beam information, and a mapping relationship between an UL beam and a SRS resource set may be configured, such as one-to-one, sequential order, cyclic order, etc., In some example embodiments, the parameter ‘useIndicatedTCIState’ may be not configured or may be not configured as ‘yes’ in case that the parameter ‘associated CSI-RS’ is configured. In some example embodiments, if ‘associated CSI-RS’ is configured, UE may obtain UL beam and/or UL precoder by measurement of associated CSI-RS.

### 2. SRI in DCI

Continue to refer to FIG. 5, the network device 110 transmits 520, to the terminal device 120, DCI for scheduling an UL transmission. The DCI comprises a first SRI and a second SRI. The first SRI indicates the number of layers (for convenience, also referred to as a first number of layers herein) to be transmitted over the first panel 125-1. The second SRI indicates the number of layers (for convenience, also referred to as a second number of layers herein) to be transmitted over the second panel 125-2. The number of layers corresponds to the number of SRI values indicated by the first or second SRI. A SRI value indicates an index of a SRS resource (i.e., i-th SRS resource).

In some embodiments, the first SRI and the second SRI may be carried in single DCI or multiple DCI. In some embodiments where multiple DCI is used, each of the multiple DCI may comprise both of the first and second SRIs. In some embodiments where multiple DCI is used, some of the multiple DCI may comprise the first SRI and some others of the multiple DCI may comprise the second SRI.

In some alternative embodiments, the first SRI and the second SRI may be carried in a configured grant.

1) First Sri Associated with First Panel

In some embodiments, the network device 110 may determine a bitwidth (for convenience, denoted as B₁) for the first SRI based on the maximum number of layers supported for the UL transmission and the number of SRS resources in the first set of SRS resources. For example, the bitwidth B₁ for the first SRI may be determined by equation (1) below.

$${B}_{1} = Ceil ( log 2 ( {\sum }_{k = 1}^{min ( {L}_{max} , {N}_{SRS , 1} )} ( \begin{matrix}{N}_{SRS , 1} \\ k\end{matrix} ) ) ) \qquad ( 1 )$$

where B₁ denotes the bitwidth for the first SRI, N_{SRS,1} denotes the number of SRS resources in the first set of SRS resources, and Lₘₐₓ denotes the maximum number of layers supported for the UL transmission. It is to be understood that equation (1) is merely an example, and any other suitable ways are also feasible.

In some alternative embodiments, the network device 110 may determine the bitwidth B₁ for the first SRI based on the maximum number of layers supported for the UL transmission, a third number of layers associated with the second SRI and the number of SRS resources in the first set of SRS resources. In some embodiments, if a transmission mode of STxMP is CJT or NCJT, the network device 110 may determine the bitwidth B₁ in this manner.

In some embodiments, the third number of layers may be equal to the second number of layers indicated by the second SRI. In some embodiments, the third number of layers may be equal to a predetermined value (for convenience, also referred to as a first predetermined value herein). In some embodiments, the first predetermined value may be the minimal number of layers to be transmitted via the second panel 125-2. For example, the first predetermined value may be 1. It is to be understood that the first predetermined value may be any other suitable values known at both the network device 110 and the terminal device 120 to have a common understanding on the bitwidth B₁.

For example, the bitwidth B₁ for the first SRI may be determined by equation (2) below.

$${B}_{1} = Ceil ( log 2 ( {\sum }_{k = 1}^{min ( {L}_{max} - {L}_{2} , {N}_{SRS , 1} )} ( \begin{matrix}{N}_{SRS , 1} \\ k\end{matrix} ) ) ) \qquad ( 2 )$$

where B₁ denotes the bitwidth for the first SRI, N_{SRS,1} denotes the number of SRS resources in the first set of SRS resources, L₂ denotes the third number of layers associated with the second SRI, and Lₘₐₓ denotes the maximum number of layers supported for the UL transmission. It is to be understood that equation (2) is merely an example, and any other suitable ways are also feasible.

In some alternative embodiments, the network device 110 may determine the bitwidth B₁ for the first SRI based on the maximum number of layers supported for the uplink transmission over the first set of antenna ports (i.e., over the first panel 125-1) and the number of SRS resources in the first set of SRS resources. In some embodiments, if a transmission mode of STxMP is CJT or NCJT, the network device 110 may determine the bitwidth B₁ in this manner. For example, the bitwidth B₁ for the first SRI may be determined by equation (3) below.

$${B}_{1} = Ceil ( log 2 ( {\sum }_{k = 1}^{min ( {L}_{max , 1} , {N}_{SRS , 1} )} ( \begin{matrix}{N}_{SRS , 1} \\ k\end{matrix} ) ) ) \qquad ( 3 )$$

where B₁ denotes the bitwidth for the first SRI, N_{SRS,1} denotes the number of SRS resources in the first set of SRS resources, L₂ denotes the third number of layers associated with the second SRI, and L_{max,1} denotes the maximum number of layers supported for the UL transmission over the first panel. It is to be understood that equation (3) is merely an example, and any other suitable ways are also feasible.

In some alternative embodiments, the network device 110 may determine a bitwidth (for convenience, denoted as B₁) for the first SRI based on the maximum number of layers supported for the UL transmission, the number of SRS resources in the first set of SRS resources and the number of SRS resources in the second set of SRS resources. In some embodiments, if a transmission mode of STxMP is SDM repetition, the network device 110 may determine the bitwidth B₁ in this manner. For example, the bitwidth B₁ for the first SRI may be determined by equation (4) below.

$${B}_{1} = Ceil ( log 2 ( {\sum }_{k = 1}^{min ( {L}_{max} , {N}_{SRS , 1} , {N}_{SRS , 2} )} ( \begin{matrix}{N}_{SRS , 1} \\ k\end{matrix} ) ) ) \qquad ( 4 )$$

where B₁ denotes the bitwidth for the first SRI, N_{SRS,1} denotes the number of SRS resources in the first set of SRS resources, N_{SRS,2} denotes the number of SRS resources in the second set of SRS resources, and Lₘₐₓ denotes the maximum number of layers supported for the UL transmission. The terminal device expects that the same number of resources is configured in the first and second sets of SRS resources if a transmission mode of STxMP is SDM repetition, i.e., N_{SRS,1}=N_{SRS,2}. It is to be understood that equation (4) is merely an example, and any other suitable ways are also feasible.

In some embodiments, the first set of SRS resources may be configured with more SRS resources, larger number of supported layers, larger value for the minimum of the number of layers and the number of resources, lower position in a set list added, or lower SRS resource set ID than the second set of SRS resources.

2) Second Sri Associated with Second Panel

In some embodiments, the network device 110 may determine a bitwidth (for convenience, denoted as B₂) for the second SRI based on the maximum number of layers supported for the UL transmission, a fourth number of layers associated with the first SRI and the number of SRS resources in the second set of SRS resources. In some embodiments, if a transmission mode of STxMP is CJT or NCJT, the network device 110 may determine the bitwidth B₂ in this manner.

In some embodiments, the fourth number of layers may be equal to the first number of layers indicated by the first SRI. In some embodiments, the fourth number of layers may be equal to a predetermined value (for convenience, also referred to as a second predetermined value herein). In some embodiments, the second predetermined value may be the minimal number of layers to be transmitted via the first panel 125-1. For example, the second predetermined value may be 1. It is to be understood that the second predetermined value may be any other suitable values known at both the network device 110 and the terminal device 120 to have a common understanding on the bitwidth B₂.

For example, the bitwidth B₂ for the second SRI may be determined by equation (5) below.

$${B}_{2} = Ceil ( log 2 ( {\sum }_{k = 1}^{min ( {L}_{max} - {L}_{1} , {N}_{SRS , 2} )} ( \begin{matrix}{N}_{SRS , 2} \\ k\end{matrix} ) ) ) \qquad ( 5 )$$

where B₂ denotes the bitwidth for the second SRI, N_{SRS,2} denotes the number of SRS resources in the second set of SRS resources, L₁ denotes the fourth number of layers associated with the first SRI, and Lₘₐₓ denotes the maximum number of layers supported for the UL transmission. It is to be understood that equation (5) is merely an example, and any other suitable ways are also feasible.

In some alternative embodiments, the network device 110 may determine a bitwidth (for convenience, denoted as B₂) for the second SRI based on the maximum number of layers supported for the UL transmission, the fourth number of layers associated with the first SRI, the maximum number of layers supported for the UL transmission over the second set of antenna ports (i.e., over the second panel 125-2) and the number of SRS resources in the second set of SRS resources. In some embodiments, if a transmission mode of STxMP is CJT or NCJT, the network device 110 may determine the bitwidth B₂ in this manner.

For example, the bitwidth B₂ for the second SRI may be determined by equation (6) below.

$${B}_{2} = Ceil ( log 2 ( {\sum }_{k = 1}^{min ( {L}_{max , 2} , {L}_{max} - {L}_{1} , {N}_{SRS , 2} )} ( \begin{matrix}{N}_{SRS , 2} \\ k\end{matrix} ) ) ) \qquad ( 6 )$$

where B₂ denotes the bitwidth for the second SRI, N_{SRS,2} denotes the number of SRS resources in the second set of SRS resources, L₁ denotes the fourth number of layers associated with the first SRI, Lₘₐₓ denotes the maximum number of layers supported for the UL transmission, and L_{max,2} denotes the maximum number of layers supported for the UL transmission over the second panel. It is to be understood that equation (6) is merely an example, and any other suitable ways are also feasible.

In some alternative embodiments, the network device 110 may determine a bitwidth (for convenience, denoted as B₂) for the second SRI based on the maximum number of layers supported for the UL transmission over the second set of antenna ports (i.e., over the second panel 125-2) and the number of SRS resources in the second set of SRS resources. In some embodiments, if a transmission mode of STxMP is CJT or NCJT, the network device 110 may determine the bitwidth B₂ in this manner.

For example, the bitwidth B₂ for the second SRI may be determined by equation (7) below.

$${B}_{2} = Ceil ( log 2 ( {\sum }_{k = 1}^{min ( {L}_{max , 2} , {N}_{SRS , 2} )} ( \begin{matrix}{N}_{SRS , 2} \\ k\end{matrix} ) ) ) \qquad ( 7 )$$

where B₂ denotes the bitwidth for the second SRI, N_{SRS,2} denotes the number of SRS resources in the second set of SRS resources, and L_{max,2} denotes the maximum number of layers supported for the UL transmission over the second panel. It is to be understood that equation (7) is merely an example, and any other suitable ways are also feasible.

In some embodiments where the first number of layers is equal to the second number of layers, the network device 110 may determine the bitwidth B₂ for the second SRI based on the maximum number of layers supported for the UL transmission and the number of SRS resources in the second set of SRS resources. In some embodiments, if a transmission mode of STxMP is SDM repetition, the network device 110 may determine the bitwidth B₂ in this manner.

For example, the bitwidth B₂ for the second SRI may be determined by equation (8) below.

$${B}_{2} = Ceil ( log 2 ( {max}_{k ∈ \{ 1 , 2 , … , min ( {L}_{max} , {N}_{SRS} , 2 ) \}} ( \begin{matrix}{N}_{SRS , 2} \\ k\end{matrix} ) ) ) \qquad ( 8 )$$

where B₂ denotes the bitwidth for the second SRI, N_{SRS,2} denotes the number of SRS resources in the second set of SRS resources, and Lₘₐₓ denotes the maximum number of layers supported for the UL transmission. It is to be understood that equation (8) is merely an example, and any other suitable ways are also feasible. In this case, N_{SRS}=N_{SRS,1}=N_{SRS,2}.

With such setting for the first and second SRIs, the number of bits used for second SRI may be reduced.

For example, as to the second SRI for NCB-based PUSCH transmission, Lₘₐₓ-L₁=1. Alternatively, min (L_{max,2}, Lₘₐₓ−L₁)=1. Alternatively, Lₘₐₓ,2=1. In these cases, Table 1 may be used for determining SRI values. Table 1 shows an example of a relationship between a bit field and indicated value in the second SRI. The SRI(s) in Table 1 refers to i-th SRS resource.

TABLE 1
An Example of Relationship between Bit field and Indicated Value

| Bit field | | Bit field | | Bit field | |
|---|---|---|---|---|---|
| mapped | SRI(s), | mapped | SRI(s), | mapped | SRI(s), |
| to index | N_{SRS, 2} = 2 | to index | N_{SRS, 2} = 3 | to index | N_{SRS, 2} = 4 |
| 0 | 0 | 0 | 0 | 0 | 0 |
| 1 | 1 | 1 | 1 | 1 | 1 |
| | | 2 | 2 | 2 | 2 |
| | | 3 | reserved | 3 | 3 |

In another example, as to the second SRI for NCB-based PUSCH transmission, Lₘₐₓ·L₁=2. Alternatively, min (L_{max,2}, Lₘₐₓ·L₁)=2. Alternatively, Lₘₐₓ,2=2. In these cases, Table 2 may be used for determining SRI values. Table 2 shows an example of a relationship between a bit field and indicated value in the second SRI in this case. The SRI(s) in Table 2 refers to i-th SRS resource.

TABLE 2
An Example of Relationship between Bit field and Indicated Value

| Bit field | | Bit field | | Bit field | |
|---|---|---|---|---|---|
| mapped | SRI(s), | mapped | SRI(s), | mapped | SRI(s), |
| to index | N_{SRS, 2} = 2 | to index | N_{SRS, 2} = 3 | to index | N_{SRS, 2} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

In still another example, as to the second SRI for NCB-based PUSCH transmission, Lₘₐₓ·L₁=3. Alternatively, min (L_{max,2}, Lₘₐₓ·L₁)=3. Alternatively, Lₘₐₓ,2=3. In these cases, Table 3 may be used for determining SRI values. Table 3 shows an example of a relationship between a bit field and indicated value in the second SRI in this case. The SRI(s) in Table 3 refers to i-th SRS resource.

TABLE 3
An Example of Relationship between Bit field and Indicated Value

| Bit field | | Bit field | | Bit field | |
|---|---|---|---|---|---|
| mapped | SRI(s), | mapped | SRI(s), | mapped | SRI(s), |
| to index | N_{SRS, 2} = 2 | to index | N_{SRS, 2} = 3 | to index | N_{SRS, 2} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14-15 | reserved |

In embodiments of the present disclosure, Lₘₐₓ, L_{max,1} and L_{max,2} may be related, e.g., Lₘₐₓ=L_{max,1}+L_{max,2}, only report two of them may be enough. More generally:
L_{max,i} is associated with i-th UE panel, and/or i-th SRS resource set;
Lₘₐₓ is associated with multiple simultaneous UE panels, and/or multiple SRS resource sets;

Applied value of Lₘₐₓ depends on PUSCH transmission mode. For example:
PUSCH STxMP CJT/NCJT: Lₘₐₓ or Lₘₐₓ,1+L_{max,2}
PUSCH TDM repetition, PUSCH STxMP SDM repetition: min (L_{max,1}, L_{max,2}), floor (Lₘₐₓ/2)
Single panel: L_{max,1} or L_{max,2}.

If UE supports operation with maxMIMO-Layers and the higher layer parameter maxMIMO-Layers of PUSCH-ServingCellConfig of the serving cell is configured, Lₘₐₓ is given by that parameter. Otherwise, Lₘₐₓ is given by the maximum number of layers for PUSCH supported by the UE for the serving cell for non-codebook based operation.

### 3) STxMP PUSCH Indication

In some embodiments, the network device 110 may transmit, to the terminal device 120, an indication that the UL transmission is at least one of a CJT transmission, a NCJT transmission or a SDM repetition. In some embodiments, the indication may be carried in a RRC configuration, for example, by STxMP enabler.

In some embodiments, the indication may be carried in DCI. In this way, a dynamic switching may be performed between STxMP mode and other modes such as a single-panel PUSCH, a single TRP PUSCH or MTRP PUSCH repetition. On the other hand, a specific codepoint for STxMP mode may be configured.

In some embodiments, the indication may indicate different STxMP modes including a CJT transmission, a NCJT transmission or a SDM repetition. For example, more RRC configured enablers and/or more specific codepoints for different modes respectively are configured.

In some embodiments where the indication may indicate multiple STxMP modes, the network device 110 may determine bitwidths for the first SRI for the multiple STxMP modes respectively and determine the largest one of the bitwidths for the multiple STxMP modes as a final bitwidth for the first SRI. Similarly, the network device 110 may determine bitwidths for the second SRI for the multiple STxMP modes respectively and determine the largest one of the bitwidths for the multiple STxMP modes as a final bitwidth for the second SRI. In this way, the determination of the first and second SRIs may be compatible with all possible STxMP modes.

### 3. Port Determination

Continue to refer to FIG. 5, upon reception of the DCI, the terminal device 120 determines 530 a first set of antenna port (for example, PUSCH port) indexes associated with the first panel 125-1. In some embodiments, the terminal device 120 may determine 531 the first SRI from the DCI based on the bitwidth B₁ for the first SRI. The terminal device 120 may determine the bitwidth B₁ in similar ways as that done by the network device 110, and thus its details are omitted here for concise. Based on the determined first SRI and the received SRS configuration, the terminal device 120 may determine 532 the first set of antenna port indexes.

In some embodiments, the terminal device 120 may determine the first set of antenna port indexes based on the first number of layers indicated by the first SRI and indexes of SRS resources in the first set of SRS resources. For example, if STxMP PUSCH, the terminal device 120 may transmit PUSCH using the same antenna ports as SRS port(s) in the SRS resource(s) indicated by both SRS resource indicators. For example, the first set of antenna port indexes may be determined by equation (9) below.

$${p}_{i} = 1000 + i \qquad ( 9 )$$

where pᵢ denotes the (i+1)-th antenna port index in the first set of antenna port indexes, and i denotes an index of a SRS resource in the first set of SRS resources and is ranged from 1 to the first number of layers. It is to be understood that equation (9) is merely an example, and any other suitable ways are also feasible.

Continue to refer to FIG. 5, the terminal device 120 further determines 540 a second set of antenna port indexes associated with the second panel 125-2. In some embodiments, the terminal device 120 may determine 541 the second SRI from the DCI based on the bitwidth B₂ for the second SRI. The terminal device 120 may determine the bitwidth B₂ in similar ways as that done by the network device 110, and thus its details are omitted here for concise. Based on the second SRI and the SRS configuration, the terminal device 120 may determine 542 the second set of antenna port indexes.

In some embodiments, the terminal device 120 may determine the second set of antenna port indexes based on indexes of SRS resources in the second set of SRS resources, the second number of layers indicated by the second SRI and the number of SRS resources in the first set of SRS resources. For example, if STxMP PUSCH, the terminal device 120 may transmit PUSCH using the same antenna ports as SRS port(s) in the SRS resource(s) indicated by both SRS resource indicators. For example, the second set of antenna port indexes may be determined by equation (10) below.

$${p}_{j} = 1000 + {N}_{S R S , 1} + j \qquad ( 10 )$$

where pⱼ denotes the (j+1)-th antenna port index in the second set of antenna port indexes, N_{SRS,1} denotes the number of SRS resources in the first set of SRS resources, and j denotes an index of a SRS resource in the second set of SRS resources and is ranged from 1 to the second number of layers. It is to be understood that equation (10) is merely an example, and any other suitable ways are also feasible.

In other words, if PUSCH STxMP, UE shall transmit PUSCH using the same antenna ports as the SRS port(s) in the SRS resource(s) indicated by both SRS resource indicators, where the SRS port in (i+1)-th SRS resource in first SRS resource set is indexed as pᵢ=1000+i, and SRS port in (j+1)-th SRS resource in second SRS resource set is indexed as pⱼ=1000+N_{SRS,1}+j. For example, if the first set includes two SRS resources, the corresponding SRS ports are indexed as 1000 and 1001. Meanwhile, if the second set also includes two SRS resources, the corresponding SRS ports are indexed as 1002 and 1003. When the first SRS resource indicator indicates SRI(s) as “1” (as in Table 1, 2, 3 for example), the corresponding PUSCH port is 1001. When the second SRS resource indicator indicates SRI(s) as “1” (as in table 1, 2, 3 for example), the corresponding PUSCH port is 1003.

In some embodiments, PUSCH share the same UL beam and/or precoder as SRS resources corresponds to the indicated SRIs.

It is to be understood that the above port determination is assuming a first set-second set order, but the order may also be a second set-first set order. In this case, UE shall transmit PUSCH using the same antenna ports as the SRS port(s) in the SRS resource(s) indicated by both SRS resource indicators, where the SRS port in (i+1)-th SRS resource in second set of SRS resources is indexed as pᵢ=1000+i, and SRS port in (j+1)-th SRS resource in first set of SRS resources is indexed as pⱼ=1000+N_{SRS,2}+j.

With reference to FIG. 5, upon determination of the first and second sets of antenna port indexes, the terminal device 120 performs 550 the UL transmission (for example, PUSCH transmission) over antenna ports (for example, PUSCH ports) corresponding to the first and second sets of antenna port indexes in the first and second sets of antenna ports. Correspondingly, the network device 110 also determines 560 the first set of antenna port indexes and determines 570 the second set of antenna port indexes in similar ways as done by the terminal device 120. Then the network device 110 can receive the UL transmission over the antenna ports corresponding to the first and second sets of antenna port indexes.

With the process 500, a NCB-based PUSCH STxMP may be better supported.

Example Implementation of STxMP with One Srs Resource Set

In this embodiment, one SRS resource set is applied for STxMP and one SRS resource indicator is provided in single DCI.

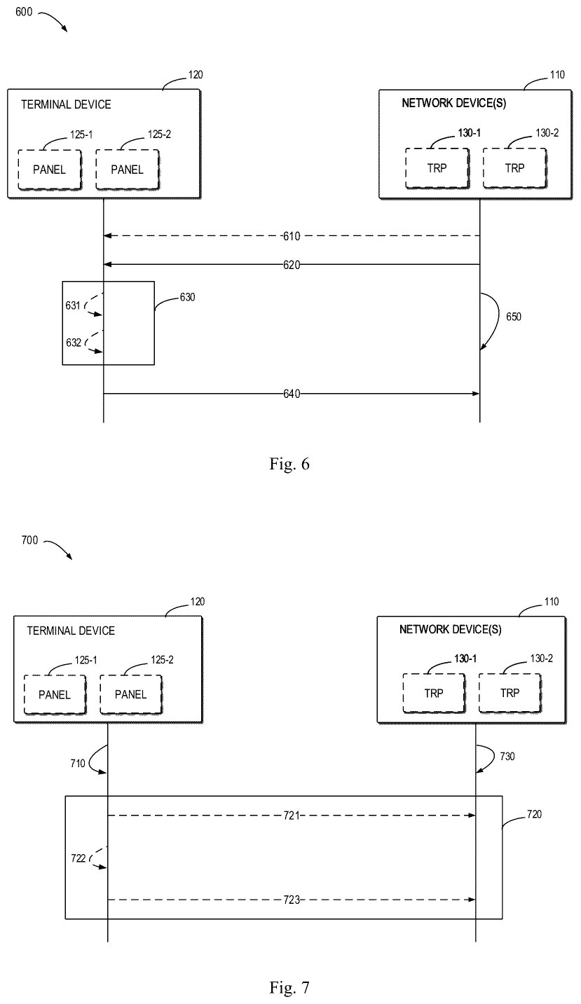

FIG. 6 illustrates a schematic diagram illustrating a process 600 of communication according to some example embodiments of the present disclosure. For the purpose of discussion, the process 600 will be described with reference to FIGS. 1A to 1C.

### 1. SRS Configuration

As shown in FIG. 6, the network device 110 may transmit 610, to the terminal device 120, a SRS configuration indicating a first set of SRS resources and a second set of SRS resources. Accordingly, the terminal device 120 may receive the SRS configuration. For example, the first set of SRS resources may be configured with parameter “usage” set to “noncodebook” for STxMP, and the second set of SRS resources may be configured for non-STxMP. Assuming that 1-port SRS resource is set for the first and second sets of SRS resources. It is to be understood that the number of the first and second sets of SRS resources is not limited to one, and any other suitable number is also feasible.

In some embodiments, SRS resources in the first set of SRS resources are allowed to be used for simultaneous transmission. For example, SRS resources in the first set may be transmitted via different UL beams. For example, the maximum number of different UL beams associated with the first set may be 2. It is to be understood that any other suitable number is also feasible.

As another example, the number of SRS resources in the same set may be smaller than or equal to a number indicated in UE capability corresponding to the set. The number indicated in the UE capability may comprise UE reported in-total values or STxMP values for at least one of the following capability: maxNumberSRS-Ports, maxNumber MIMO-LayersNonCB-PUSCH, maxNumberSimultaneousSRS-ResourceTx, maxNumberSRS-ResourcePerSet. It is to be understood that any other suitable forms of capability are also feasible.

In still another example, SRS resources in the first set may be divided into two subsets. One of the two subsets may correspond to the first panel, and the other of the two subsets may correspond to the second panel.

In some embodiments, the first and second sets of SRS resources are not allowed to be used for simultaneous transmission. In other words, SRS resources in the first set and SRS resources in the second sets are not allowed to be transmitted simultaneously.

In some embodiments, the first set of SRS resources is configured with the parameter ‘useIndicatedTCIState’. In some example embodiments, the indicated TCI state may contain at least two UL beam information, and a mapping relationship between an UL beam and a SRS resource set may be configured, such as one-to-one, sequential order, cyclic order, etc., In some example embodiments, the parameter ‘useIndicatedTCIState’ may be not configured or may be not configured as ‘yes’ in case that the parameter ‘associated CSI-RS’ is configured. In some example embodiments, if ‘associated CSI-RS’ is configured, UE may obtain UL beam and/or UL precoder by measurement of associated CSI-RS. For example, the associated CSI-RS may be measured via two UE panels simultaneously. As another example, the associated CSI-RS may refer to two different CSI-RS resources transmitted simultaneously.

### 2. SRI in DCI

Continue to refer to FIG. 6, the network device 110 transmits 620, to the terminal device 120, DCI for scheduling an UL transmission. The DCI comprises a SRI indicating the number of layers (for convenience, also referred to as a first number of layers herein) to be transmitted over each of the first panel 125-1 and the second panel 125-2. The number of layers corresponds to the number of SRI values indicated by the SRI. A SRI value indicates an index of a SRS resource (i.e., i-th SRS resource).

In some embodiments, the SRI may be carried in single DCI or multiple DCI. In some embodiments where multiple DCI are used, the multiple DCI may comprise the same or different SRI.

In some alternative embodiments, the SRI may be carried in a configured grant.

In some embodiments, the network device 110 may determine a bitwidth (for convenience, denoted as B₃) for the SRI based on the maximum number of layers supported for the UL transmission and the number of SRS resources in the first set of SRS resources. For example, the bitwidth B₃ for the SRI may be determined by equation (11) below.

$${B}_{3} = Ceil ( log 2 ( {\sum }_{k = 1}^{min ( {L}_{max} , {N}_{SRS , 1} )} ( \begin{matrix}{N}_{SRS , 1} \\ k\end{matrix} ) ) ) \qquad ( 11 )$$

where B₃ denotes the bitwidth for the SRI, N_{SRS,1} denotes the number of SRS resources in the first set of SRS resources, and Lₘₐₓ denotes the maximum number of layers supported for the UL transmission. It is to be understood that equation (11) is merely an example, and any other suitable ways are also feasible.

In some alternative embodiments, the network device 110 may determine the bitwidth B₃ for the SRI based on the maximum number of layers supported for the UL transmission and a half of the number of SRS resources in the first set of SRS resources. In some embodiments, if a transmission mode of STxMP is SDM repetition, the network device 110 may determine the bitwidth B₃ in this manner. For example, the bitwidth B₃ for the SRI may be determined by equation (12) below.

$${B}_{3} = Ceil ( log 2 ( {\sum }_{k = 1}^{min ( {L}_{max} , {N}_{SRS , 1} / 2 )} ( \begin{matrix}{N}_{SRS , 1} / 2 \\ k\end{matrix} ) ) ) \qquad ( 12 )$$

where B₃ denotes the bitwidth for the SRI, N_{SRS,1} denotes the number of SRS resources in the first set of SRS resources, and Lₘₐₓ denotes the maximum number of layers supported for the UL transmission. It is to be understood that equation (12) is merely an example, and any other suitable ways are also feasible.

In this example, N_{SRS,1}/2 is suitable for the case with identical panels. As an alternative, N_{SRS,1}/2 may be further restricted to floor (N_{SRS,1}/2). As another alternative, N_{SRS,1}/2 may be further restricted to min (N_{SRS,subset1}, N_{SRS,subset2}), where N_{SRS,subset1} denotes the number of SRS resources in a first subset of the first set of SRS resources, and N_{SRS,subset2} denotes the number of SRS resources in a second subset of the first set of SRS resources.

In some embodiments, if only one layer PUSCH repetition is assumed, both panels transmit one layer PUSCH. In this case, SRI value(s) in the SRI may comprise SRI value(s) associated with different panels or subsets, as shown in Tables 4 and 5. In some embodiments, if two-layer PUSCH repetition is assumed, both panels transmit two-layer PUSCH. In this case, the total occupied port number is 4. Table 4 shows an example of a relationship between a bit field and an indicated value in the SRI in the case that Lₘₐₓ=1.

TABLE 4
An Example of Relationship between Bit field and Indicated Value

| Bit field | | Bit field | |
|---|---|---|---|
| mapped to | | mapped to | |
| index | SRI(s), N_{SRS, 1} = 3 | index | SRI(s), N_{SRS, 1} = 4 |
| 0 | 0, 2 | 0 | 0, 2 |
| 1 | 1, 2 | 1 | 0, 3 |
| | | 2 | 1, 2 |
| | | 3 | 1, 3 |

Table 5 shows an example of a relationship between a bit field and an indicated value in the SRI in the case that Lₘₐₓ=2.

TABLE 5
An Example of Relationship between Bit field and Indicated Value

| Bit field | | Bit field | |
|---|---|---|---|
| mapped to | | mapped to | |
| index | SRI(s), N_{SRS, 1} = 3 | index | SRI(s), N_{SRS, 1} = 4 |
| 0 | 0, 2 | 0 | 0, 2 |
| 1 | 1, 2 | 1 | 0, 3 |
| | | 2 | 1, 2 |
| | | 3 | 1, 3 |
| | | 4 | 0, 1, 2, 3 |
| | | 5-7 | reserved |

In some embodiments, the network device 110 may transmit, to the terminal device 120, an indication that the UL transmission is at least one of a CJT transmission, a NCJT transmission or a SDM repetition. In some embodiments, the indication may be carried in a RRC configuration, for example, by STxMP enabler.

In some embodiments, the indication may be carried in DCI. In this way, a dynamic switching may be performed between STxMP mode and other modes such as a single-panel PUSCH, a single TRP PUSCH or MTRP PUSCH repetition. On the other hand, a specific codepoint for STxMP mode may be configured.

In some embodiments, the indication may indicate different STxMP modes including a CJT transmission, a NCJT transmission or a SDM repetition. For example, more RRC configured enablers and/or more specific codepoints for different modes respectively are configured.

In some embodiments where the indication may indicate multiple STxMP modes, the network device 110 may determine bitwidths for the SRI for the multiple STxMP modes respectively and determine the largest one of the bitwidths for the multiple STxMP modes as a final bitwidth for the SRI. In this way, the determination of the SRI may be compatible with all possible STxMP modes.

In some embodiments, if the determined bitwidth for the SRI is smaller than a reference bitwidth, the determined bitwidth for the SRI may be padded with zero to have the same bit length with the reference bitwidth. The reference bitwidth may be a sum of a first bitwidth calculated for a set of SRS resources and a second bitwidth calculated for another set of SRS resources. Each of the set of SRS resources and the other set of SRS resources may correspond to the second set of SRS resources configured for non-STxMP. For example, the first bitwidth (denoted as B) may be determined by equation (13) below, and the second bitwidth (denoted as B′) may be determined by equation (14) below.

$$B = Ceil ( log 2 ( {\sum }_{k = 1}^{min ( {L}_{max} , {N}_{SRS , 2} )} ( \begin{matrix}{N}_{SRS , 2} \\ k\end{matrix} ) ) ) \qquad ( 13 )$$

$${B}^{′} = Ceil ( log 2 ( {max}_{k ∈ \{ 1 , 2 , … , min ( {L}_{max} , {N}_{S R S} , 2 ) \}} ( \begin{matrix}{N}_{SRS , 3} \\ k\end{matrix} ) ) ) \qquad ( 14 )$$

where B denotes the first bitwidth, and B′ denotes the second bitwidth, N_{SRS,2} denotes the number of SRS resources in the set of SRS resources, N_{SRS,3} denotes the number of SRS resources in the other set of SRS resources, and Lₘₐₓ denotes the maximum number of layers supported for the UL transmission. For example, N_{SRS,2}=N_{SRS,3}. It is to be understood that equations (13) and (14) are merely examples, and any other suitable ways are also feasible.

In embodiments of the present disclosure, Lₘₐₓ, L_{max,1} and L_{max,2} may be related, e.g., Lₘₐₓ=Lₘₐₓ,1+L_{max,2}, only report two of them may be enough. More generally:
Lₘₐₓ,¿ is associated with i-th UE panel, and/or i-th SRS resource set;
Lₘₐₓ is associated with multiple simultaneous UE panels, and/or multiple SRS resource sets;

Applied value of Lₘₐₓ depends on PUSCH transmission mode. For example:
PUSCH STxMP CJT/NCJT: Lₘₐₓ or L_{max,1}+L_{max,2}
PUSCH TDM repetition, PUSCH STxMP SDM repetition: min (L_{max,1}, L_{max,2}), floor (Lₘₐₓ/2)
Single panel: L_{max,1} or L_{max,2}.

If UE supports operation with maxMIMO-Layers and the higher layer parameter maxMIMO-Layers of PUSCH-ServingCellConfig of the serving cell is configured, Lₘₐₓ is given by that parameter. Otherwise, Lₘₐₓ is given by the maximum number of layers for PUSCH supported by the UE for the serving cell for non-codebook based operation.

### 3. Port Determination

Continue to refer to FIG. 6, upon reception of the DCI, the terminal device 120 determines 630 a set of antenna port indexes associated with the first panel 125-1 and the second panel 125-2. In some embodiments, the terminal device 120 may determine 631 the SRI from the DCI based on the bitwidth B₃ for the SRI. The terminal device 120 may determine the bitwidth B₃ in similar ways as that done by the network device 110, and thus its details are omitted here for concise. Based on the determined SRI and the received SRS configuration, the terminal device 120 may determine 632 the set of antenna port indexes.

In some embodiments, the terminal device 120 may determine the set of antenna port indexes based on the number of layers indicated by the SRI, indexes of SRS resources in the first set of SRS resources and the number of SRS resources in the first set of SRS resources. For example, PUSCH shares the same UL beam and/or precoder as SRS resources corresponding to the indicated SRI. If STxMP PUSCH, the terminal device 120 may transmit PUSCH using the same antenna ports as SRS port(s) in the SRS resource(s) indicated by both SRS resource indicators. For example, if i≥N_{SRS,1}/2, the set of antenna port indexes may be determined by equation (15) below.

$${p}_{i} = 1000 + i - {N}_{S R S , 1} / 2 \qquad ( 15 )$$

where pᵢ denotes the (i+1)-th antenna port index in the set of antenna port indexes, N_{SRS,1} denotes the number of SRS resources in the first set of SRS resources, and i denotes an index of a SRS resource in the first set of SRS resources and is ranged from 1 to the number of layers. It is to be understood that equation (14) is merely an example, and any other suitable ways are also feasible. If i<N_{SRS,1}/2, the set of antenna port indexes may be determined by pᵢ=1000+i.

For example, if SRS resources 0 and 1 are associated with the first panel, and SRS resources 2 and 3 are associated with the second panel, SRS port in 2nd or 3rd SRS resource is indexed as 1000 and 1001. If the first set comprises 4 SRS resources, the corresponding SRS ports are indexed as 1000 and 1001. When the first SRS resource indicator indicates SRI(s) as “1, 2” (as in Tables 4 and 5 for example), the corresponding PUSCH port is 1000, 1001. The terminal device transmits the same 1-layer PUSCH simultaneously with both panels, where port 1001 is used with the first panel and port 1000 is used with the second panel.

In this example, N_{SRS,1}/2 is suitable for the case with identical panels. As an alternative, N_{SRS,1}/2 may be further restricted to floor (N_{SRS,1}/2). As another alternative, N_{SRS,1}/2 may be further restricted to min (N_{SRS,subset1}, N_{SRS,subset2}), where N_{SRS,subset1} denotes the number of SRS resources in a first subset of the first set of SRS resources, and N_{SRS,subset2} denotes the number of SRS resources in a second subset of the first set of SRS resources. For example, if SRS resource 0 is associated with the first panel, and SRS resources 1, 2 and 3 are associated with the second panel, SRS ports in the SRS resources 1, 2 and 3 are indexed as 1000, 1001 and 1002.

As an alternative, the set of antenna port indexes may be determined by equation (16) below.

$${p}_{i} = 1000 + i mod ( {N}_{S R S , 1} / 2 ) \qquad ( 16 )$$

where pᵢ denotes the (i+1)-th antenna port index in the set of antenna port indexes, N_{SRS,1} denotes the number of SRS resources in the first set of SRS resources, and i denotes an index of a SRS resource in the first set of SRS resources and is ranged from 1 to the number of layers. It is to be understood that equation (16) is merely an example, and any other suitable ways are also feasible.

With reference to FIG. 6, upon determination of the set of antenna port indexes, the terminal device 120 performs 640 the UL transmission over a set of antenna ports corresponding to the set of antenna port indexes in the first and second sets of antenna ports. Correspondingly, the network device 110 also determines 650 the set of antenna port indexes in similar ways as done by the terminal device 120. Then the network device 110 can receive the UL transmission over the set of antenna ports corresponding to the first and second sets of antenna port indexes.

With the process 600, a NCB-based PUSCH STxMP may also be better supported.

Example Implementation of STxMP with Default Panel

In this embodiment, a default panel is defined for STxMP. The default panel is associated with a BWP configured for the terminal device 120. The default panel may be also referred to as a default capability value set. In other words, the default panel corresponds to a set of capability values, i.e., the default capability value set.

FIG. 7 illustrates a schematic diagram illustrating a process 700 of communication according to some example embodiments of the present disclosure. For the purpose of discussion, the process 700 will be described with reference to FIGS. 1A to 1C.

With reference to FIG. 7, the terminal device 120 determines 710 a default capability value set associated with a BWP configured for the terminal device 120. In some embodiments, a panel with a lower capability may be determined as the default panel. In some alternative embodiments, a panel with a higher capability may be determined as the default panel. It is to be understood that any other suitable ways are also feasible.

In some embodiments, a default BWP may be associated with the panel with lower capability. In other words, a BWP associated with the panel with lower capability is the default BWP. For example, a BWP with a specific ID may be regarded as the default BWP.

In addition, default panel assumption means UE does not expect (or, “UE is not expected”, or “UE may not”) to transmit beyond its default panel capability (or, “to transmit with configuration associated with non-default panel”), this applies to at least SRS/PUCCH/PUSCH transmission, UL BWP selection, UL beam selection. For example, if UE report 2 capability values or capability value sets as 2-port SRS in capability value or capability value set 1 and 4-port SRS in capability value or capability value set 2, initially, more than 2-layer PUSCH transmission is not supported.

‘Panel with lower capability’ may refer to lower capability value(s) or capability value set(s) at least including lower value of maxNumberSRS-Ports, maxNumberMIMO-LayersNonCB-PUSCH, maxNumberSimultaneousSRS-ResourceTx, maxNumberSRS-ResourcePerSet. If single-panel and STxMP is indicated explicitly, the panel with lower capability may refer to single-panel transmission.

Continue to refer to FIG. 7, the terminal device 120 performs 720 an UL transmission based on the default capability value set. In some embodiments, the terminal device 120 may perform 721 an initial transmission with the network device 110 by applying the default capability value set.

In some embodiments, the terminal device 120 may determine 722 whether a fallback condition is satisfied. If the fallback condition is satisfied, the terminal device 120 may perform 723 an UL transmission by applying the default capability value set or falling back to the default capability value set. Accordingly, the network device 110 may also determines 730 the default capability value set for the terminal device 120 and receives the UL transmission based on the default capability value set.

In some embodiments, the scenarios requiring fallback to the default capability value set may comprise at least one of the following:
Initial transmission during a period between reporting capability value set and transmitting a first correspondence report
During initial access or random access
During a period after reconfiguration, initial access or random access
During a period when link is failed or link is poor, for example, with a worse BLER/RSRP/SINR than a threshold
Scheduled by a specific DCI format, e.g., fallback DCI format, more specially, DCI format 0_0
Fail to receive a confirmation message for the correspondence report after transmitting the correspondence report for a certain duration
When Default BWP/CC activated
When Default TCI state, spatial relation or QCL assumption applied.

With the default panel associated with the BWP, a BWP switching indication may be used to indicate a switching among UE panels. Thus, misalignment on UE UL panel assumption in special scenarios may be avoided.

It is to be understood that the default panel may be applicable to any suitable UL transmission, for example, NCB-based or CB-based PUSCH transmission, STxMP or non-STxMP. The present disclosure does not limit this aspect.

### Example Implementation of UE Capability Reporting

Embodiments of the present disclosure also provide a solution of reporting UE capability. In the solution, the terminal device 120 may transmit or report, to the network device 110, at least one of the following: a first set of capability values of the terminal device 120 associated with the first set of antenna ports; a second set of capability values of the terminal device 120 associated with the second set of antenna ports; or a third set of capability values of the terminal device associated with the first and second sets of antenna ports.

In other words, the terminal device 120 may report per-panel and in-total values for categories of UE capability. Alternatively, the terminal device 120 may report single panel and STxMP values for categories of UE capability.

The categories of UE capability may comprise at least one of the following:
supportedSRS-Resources

Defines support of SRS resources. The capability signalling comprising indication of:
maxNumberAperiodicSRS-PerBWP indicates supported maximum number of aperiodic SRS resources that can be configured for the UE per each BWP
maxNumberAperiodicSRS-PerBWP-PerSlot indicates supported maximum number of aperiodic SRS resources per slot in the BWP
maxNumberPeriodicSRS-PerBWP indicates supported maximum number of periodic SRS resources per BWP
maxNumberPeriodicSRS-PerBWP-PerSlot indicates supported maximum number of periodic SRS resources per slot in the BWP
maxNumberSemiPersistentSRS-PerBWP indicate supported maximum number of semi-persistent SRS resources that can be configured for the UE per each BWP
maxNumberSemiPersistentSRS-PerBWP-PerSlot indicates supported maximum number of semi-persistent SRS resources per slot in the BWP
maxNumberSRS-Ports-PerResource indicates supported maximum number of SRS antenna port per each SRS resource

If this field is not included, the UE supports one periodic, one aperiodic, no semi-persistent SRS resources per BWP and one periodic, one aperiodic, no semi-persistent SRS resources per BWP per slot and one SRS antenna port per SRS resource.
srs-AssocCSI-RS

Parameters for the calculation of the precoder for SRS transmission based on channel measurements using associated NZP CSI-RS resource (srs-AssocCSI-RS). UE supporting this feature shall also indicate support of non-codebook based PUSCH transmission.

This capability signalling includes list of the following parameters:
maxNumberTxPortsPerResource indicates the maximum number of Tx ports in a resource;
maxNumberResourceSTxMP indicates the maximum number of resources for simultaneous transmission across multiple UE panels;
maxNumberResourcesPerBand indicates the maximum number of resources across all CCs within a band simultaneously;
totalNumberTxPortsPerBand indicates the total number of Tx ports across all CCs within a band simultaneously.
maxNumberMIMO-LayersNonCB-PUSCH

Defines supported maximum number of MIMO layers at the UE for PUSCH transmission using non-codebook precoding. This feature is not supported for SUL.

UE supporting non-codebook based PUSCH transmission shall indicate support of maxNumberMIMO-LayersNonCB-PUSCH, maxNumberSRS-ResourcePerSet and maxNumberSimultaneousSRS-ResourceTx together.
maxNumberSimultaneousSRS-ResourceTx

Defines the maximum number of simultaneous transmitted SRS resources at one symbol for non-codebook based transmission to the UE. This feature is not supported for SUL.
maxNumberSRS-ResourcePerSet

Defines the maximum number of SRS resources per SRS resource set configured for codebook or non-codebook based transmission to the UE. This feature is not supported for SUL.

### Example Implementation of Relaxed Restriction

At least the following restrictions need to be removed to support UE with multiple panels with different panel capability and can be used simultaneously.

For example, when two SRS resource sets are configured in srs-ResourceSetToAddModList or srs-ResourceSetToAddModListDCI-0-2 with higher layer parameter usage in SRS-ResourceSet set to ‘nonCodebook’, the UE is not expected to be configured with different number of SRS resources in the two SRS resource sets. If STxMP is supported, this restriction may be removed. In other words, if STxMP is supported, different number of SRS resources can be configured in the two SRS resource sets.

As another example, UE can be configured with only one NZP CSI-RS resource for the SRS resource set with higher layer parameter usage in SRS-ResourceSet set to ‘nonCodebook’ if configured. If STxMP is supported, this restriction may be removed. In other words, if STxMP is supported, more than one NZP CSI-RS resources can be configured. In addition, more than one NZP CSI-RS resources can be transmitted simultaneously.

### Example Implementation of Methods

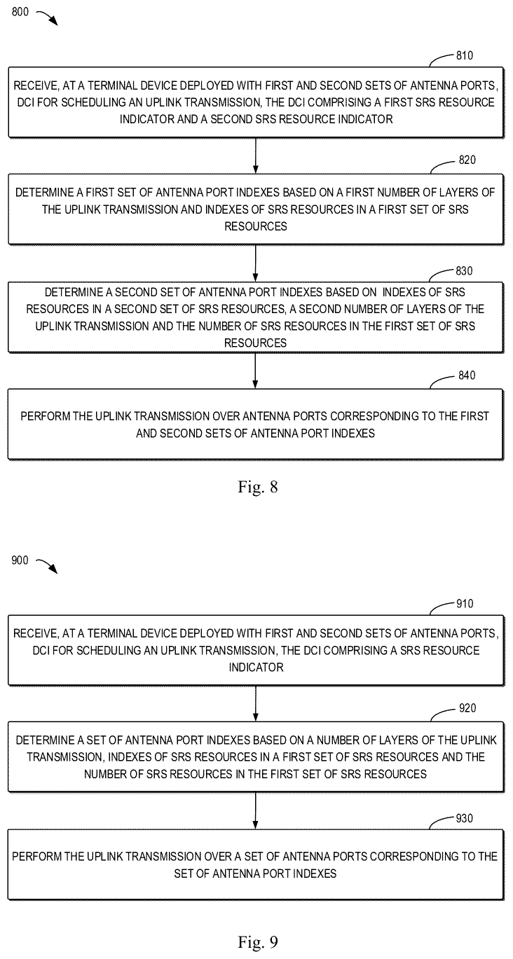

Accordingly, embodiments of the present disclosure provide methods of communication implemented at a terminal device and a network device. These methods will be described below with reference to FIGS. 8 to 13.

FIG. 8 illustrates an example method 800 of communication implemented at a terminal device in accordance with some embodiments of the present disclosure. For example, the method 800 may be performed at the terminal device 120 as shown in FIGS. 1A to 1C. For the purpose of discussion, the method 800 will be described with reference to FIGS. 1A to 1C. It is to be understood that the method 800 may include additional blocks not shown and/or may omit some blocks as shown, and the scope of the present disclosure is not limited in this regard.

At block 810, the terminal device 120 receives DCI for scheduling an uplink transmission, the DCI comprising a first SRS resource indicator and a second SRS resource indicator.

At block 820, the terminal device 120 determines a first set of antenna port indexes based on a first number of layers of the uplink transmission and indexes of SRS resources in a first set of SRS resources, the first number of layers being indicated by the first SRS resource indicator and being transmitted over the first set of antenna ports.

At block 830, the terminal device 120 determines a second set of antenna port indexes based on indexes of SRS resources in a second set of SRS resources, a second number of layers of the uplink transmission and the number of SRS resources in the first set of SRS resources, the second number of layers being indicated by the second SRS resource indicator and being transmitted over the second set of antenna ports.

At block 840, the terminal device 120 performs the uplink transmission over antenna ports corresponding to the first and second sets of antenna port indexes in the first and second sets of antenna ports.

In some embodiments, the terminal device 120 may receive a SRS configuration indicating the first set of SRS resources and the second set of SRS resources, wherein SRS resources in the first and second sets of SRS resources are allowed to be used for simultaneous transmission, and the first and second sets of SRS resources are configured with the same time-domain configuration and the same uplink beam configuration.

In some embodiments, the terminal device 120 may determine the first SRS resource indicator from the DCI by: determining a bitwidth for the first SRS resource indicator based on the maximum number of layers supported for the uplink transmission, a third number of layers associated with the second SRS resource indicator and the number of SRS resources in the first set of SRS resources; or determining a bitwidth for the first SRS resource indicator based on the maximum number of layers supported for the uplink transmission over the first set of antenna ports and the number of SRS resources in the first set of SRS resources. In some embodiments, the third number of layers is equal to the second number of layers or a first predetermined value.

In some embodiments, the terminal device 120 may determining the second SRS resource indicator from the DCI by: determining a bitwidth for the second SRS resource indicator based on the maximum number of layers supported for the uplink transmission, a fourth number of layers associated with the first SRS resource indicator and the number of SRS resources in the second set of SRS resources; determining a bitwidth for the second SRS resource indicator based on the maximum number of layers supported for the uplink transmission, the fourth number of layers associated with the first SRS resource indicator, the maximum number of layers supported for the uplink transmission over the second set of antenna ports and the number of SRS resources in the second set of SRS resources; or determining a second bitwidth for the second SRS resource indicator based on the maximum number of layers supported for the uplink transmission over the second set of antenna ports and the number of SRS resources in the second set of SRS resources. In some embodiments, the fourth number of layers is equal to the first number of layers or a second predetermined value.

In some embodiments, the terminal device 120 may receive an indication indicating that the uplink transmission is a CJT transmission or a NCJT transmission.

In some embodiments, the terminal device 120 may transmit at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel; and the uplink transmission is a NCB-based PUSCH and performed via a plurality of TRPs.

FIG. 9 illustrates another example method 900 of communication implemented at a terminal device in accordance with some embodiments of the present disclosure. For example, the method 900 may be performed at the terminal device 120 as shown in FIGS. 1A to 1C. For the purpose of discussion, the method 900 will be described with reference to FIGS. 1A to 1C. It is to be understood that the method 900 may include additional blocks not shown and/or may omit some blocks as shown, and the scope of the present disclosure is not limited in this regard.

At block 910, the terminal device 120 receives DCI for scheduling an uplink transmission, the DCI comprising a SRS resource indicator.

At block 920, the terminal device 120 determines a set of antenna port indexes based on a number of layers of the uplink transmission, indexes of SRS resources in a first set of SRS resources and the number of SRS resources in the first set of SRS resources, the number of layers being indicated by the SRS resource indicator and being transmitted over each of the first and second sets of antenna ports.

At block 930, the terminal device 120 performs the uplink transmission over a set of antenna ports corresponding to the set of antenna port indexes in the first and second sets of antenna ports.

In some embodiments, the terminal device 120 may receive a SRS configuration indicating the first set of SRS resources and a second set of SRS resources, wherein SRS resources in the first set of SRS resources are allowed to be used for simultaneous transmission, and the first and second sets of SRS resources are not allowed to be used for simultaneous transmission.

In some embodiments, the terminal device 120 may determine the SRS resource indicator from the DCI by: determining a bitwidth for the SRS resource indicator based on the maximum number of layers supported for the uplink transmission and a half of the number of SRS resources in the first set of SRS resources.

In some embodiments, the terminal device 120 may receive an indication indicating that the uplink transmission is a SDM repetition.

In some embodiments, the terminal device 120 may transmit at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel; and the uplink transmission is a NCB-based PUSCH and performed via a plurality of TRPs.

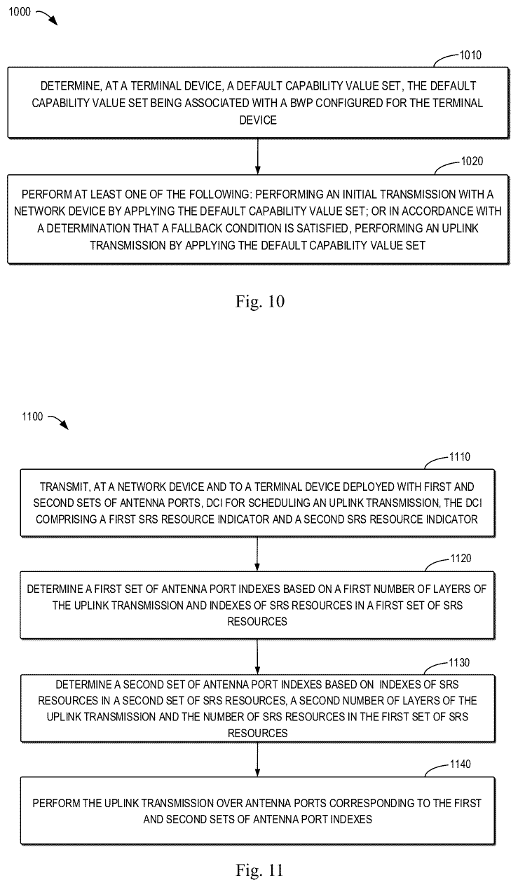

FIG. 10 illustrates still another example method 1000 of communication implemented at a terminal device in accordance with some embodiments of the present disclosure. For example, the method 1000 may be performed at the terminal device 120 as shown in FIGS. 1A to 1C. For the purpose of discussion, the method 1000 will be described with reference to FIGS. 1A to 1C. It is to be understood that the method 1000 may include additional blocks not shown and/or may omit some blocks as shown, and the scope of the present disclosure is not limited in this regard.

At block 1010, the terminal device 120 determines a default capability value set, the default capability value set being associated with a BWP configured for the terminal device.

At block 1020, the terminal device 120 performs at least one of the following: performing an initial transmission with a network device by applying the default capability value set; or in accordance with a determination that a fallback condition is satisfied, performing an uplink transmission by applying the default capability value set.

FIG. 11 illustrates an example method 1100 of communication implemented at a network device in accordance with some embodiments of the present disclosure. For example, the method 1100 may be performed at the network device 110 (the network device 110-1 or 110-2) as shown in FIGS. 1A to 1C. For the purpose of discussion, the method 1100 will be described with reference to FIGS. 1A to 1C. It is to be understood that the method 1100 may include additional blocks not shown and/or may omit some blocks as shown, and the scope of the present disclosure is not limited in this regard.

At block 1110, the network device 110 transmits DCI for scheduling an uplink transmission, the DCI comprising a first SRS resource indicator and a second SRS resource indicator.

At block 1120, the network device 110 determines a first set of antenna port indexes based on a first number of layers of the uplink transmission and indexes of SRS resources in a first set of SRS resources, the first number of layers being indicated by the first SRS resource indicator and being transmitted over the first set of antenna ports.

At block 1130, the network device 110 determines a second set of antenna port indexes based on indexes of SRS resources in a second set of SRS resources, a second number of layers of the uplink transmission and the number of SRS resources in the first set of SRS resources, the second number of layers being indicated by the second SRS resource indicator and being transmitted over the second set of antenna ports.

At block 1140, the network device 110 performs the uplink transmission over antenna ports corresponding to the first and second sets of antenna port indexes in the first and second sets of antenna ports.

In some embodiments, the network device 110 may transmit a SRS configuration indicating the first set of SRS resources and the second set of SRS resources, wherein SRS resources in the first and second sets of SRS resources are allowed to be used for simultaneous transmission, and the first and second sets of SRS resources are configured with the same time-domain configuration and the same uplink beam configuration.

In some embodiments, the network device 110 may determine the first SRS resource indicator by: determining a bitwidth for the first SRS resource indicator based on the maximum number of layers supported for the uplink transmission, a third number of layers associated with the second SRS resource indicator and the number of SRS resources in the first set of SRS resources; or determining a bitwidth for the first SRS resource indicator based on the maximum number of layers supported for the uplink transmission over the first set of antenna ports and the number of SRS resources in the first set of SRS resources. In some embodiments, the third number of layers is equal to the second number of layers or a first predetermined value.

In some embodiments, the network device 110 may determining the second SRS resource indicator by: determining a bitwidth for the second SRS resource indicator based on the maximum number of layers supported for the uplink transmission, a fourth number of layers associated with the first SRS resource indicator and the number of SRS resources in the second set of SRS resources; determining a bitwidth for the second SRS resource indicator based on the maximum number of layers supported for the uplink transmission, the fourth number of layers associated with the first SRS resource indicator, the maximum number of layers supported for the uplink transmission over the second set of antenna ports and the number of SRS resources in the second set of SRS resources; or determining a second bitwidth for the second SRS resource indicator based on the maximum number of layers supported for the uplink transmission over the second set of antenna ports and the number of SRS resources in the second set of SRS resources. In some embodiments, the fourth number of layers is equal to the first number of layers or a second predetermined value.

In some embodiments, the network device 110 may transmit an indication indicating that the uplink transmission is a CJT transmission or a NCJT transmission.

In some embodiments, the network device 110 may receive at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel; and the uplink transmission is a NCB-based PUSCH and performed via a plurality of TRPs.

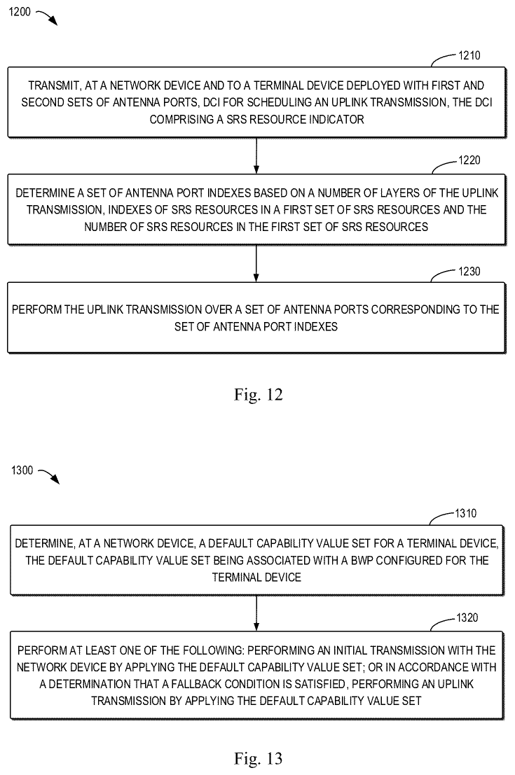

FIG. 12 illustrates another example method 1200 of communication implemented at a network device in accordance with some embodiments of the present disclosure. For example, the method 1200 may be performed at the network device 110 (the network device 110-1 or 110-2) as shown in FIGS. 1A to 1C. For the purpose of discussion, the method 1200 will be described with reference to FIGS. 1A to 1C. It is to be understood that the method 1200 may include additional blocks not shown and/or may omit some blocks as shown, and the scope of the present disclosure is not limited in this regard.

At block 1210, the network device 110 transmits DCI for scheduling an uplink transmission, the DCI comprising a SRS resource indicator.

At block 1220, the network device 110 determines a set of antenna port indexes based on a number of layers of the uplink transmission, indexes of SRS resources in a first set of SRS resources and the number of SRS resources in the first set of SRS resources, the number of layers being indicated by the SRS resource indicator and being transmitted over each of the first and second sets of antenna ports.

At block 1230, the network device 110 performs the uplink transmission over a set of antenna ports corresponding to the set of antenna port indexes in the first and second sets of antenna ports.

In some embodiments, the network device 110 may transmit a SRS configuration indicating the first set of SRS resources and a second set of SRS resources, wherein SRS resources in the first set of SRS resources are allowed to be used for simultaneous transmission, and the first and second sets of SRS resources are not allowed to be used for simultaneous transmission.

In some embodiments, the network device 110 may determine the SRS resource indicator from the DCI by: determining a bitwidth for the SRS resource indicator based on the maximum number of layers supported for the uplink transmission and a half of the number of SRS resources in the first set of SRS resources.

In some embodiments, the network device 110 may transmit an indication indicating that the uplink transmission is a SDM repetition.

In some embodiments, the network device 110 may receive at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel; and the uplink transmission is a NCB-based PUSCH and performed via a plurality of TRPs.

FIG. 13 illustrates still another example method 1300 of communication implemented at a network device in accordance with some embodiments of the present disclosure. For example, the method 1300 may be performed at the network device 110 (the network device 110-1 or 110-2) as shown in FIGS. 1A to 1C. For the purpose of discussion, the method 1300 will be described with reference to FIGS. 1A to 1C. It is to be understood that the method 1300 may include additional blocks not shown and/or may omit some blocks as shown, and the scope of the present disclosure is not limited in this regard.

At block 1310, the network device 110 determines a default capability value set for the terminal device 120, the default capability value set being associated with a BWP configured for the terminal device.

At block 1320, the network device 110 performs at least one of the following: performing an initial transmission with the terminal device 120 by applying the default capability value set; or in accordance with a determination that a fallback condition is satisfied, performing an uplink transmission by applying the default capability value set.

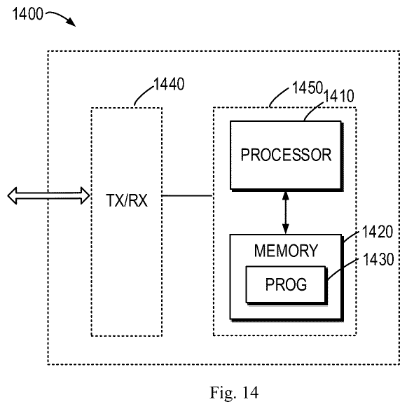

FIG. 14 is a simplified block diagram of a device 1400 that is suitable for implementing embodiments of the present disclosure. The device 1400 can be considered as a further example implementation of the terminal device 120 and the network devices 110-1 and 110-2 as shown in FIGS. 1A to 1C. Accordingly, the device 1400 can be implemented at or as at least a part of the terminal 120 and the network devices 110-1 and 110-2.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2 interface for bidirectional communications between eNBs, SI interface for communication between a Mobility Management Entity (MME)/Serving Gateway (S-GW) and the eNB, Un interface for communication between the eNB and a relay node (RN), or Uu interface for communication between the eNB and a terminal device.

The program 1430 is assumed to include program instructions that, when executed by the associated processor 1410, enable the device 1400 to operate in accordance with the embodiments of the present disclosure, as discussed herein with reference to FIGS. 1A to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a terminal device deployed with first and second sets of antenna ports comprises a circuitry configured to: receive DCI for scheduling an uplink transmission, the DCI comprising a first SRS resource indicator and a second SRS resource indicator; determine a first set of antenna port indexes based on a first number of layers of the uplink transmission and indexes of SRS resources in a first set of SRS resources, the first number of layers being indicated by the first SRS resource indicator and being transmitted over the first set of antenna ports; determine a second set of antenna port indexes based on indexes of SRS resources in a second set of SRS resources, a second number of layers of the uplink transmission and the number of SRS resources in the first set of SRS resources, the second number of layers being indicated by the second SRS resource indicator and being transmitted over the second set of antenna ports; and performs the uplink transmission over antenna ports corresponding to the first and second sets of antenna port indexes in the first and second sets of antenna ports.

In some embodiments, the circuitry may be further configured to: receive a SRS configuration indicating the first set of SRS resources and the second set of SRS resources, wherein SRS resources in the first and second sets of SRS resources are allowed to be used for simultaneous transmission, and the first and second sets of SRS resources are configured with the same time-domain configuration and the same uplink beam configuration.

In some embodiments, the circuitry may be further configured to: determine the first SRS resource indicator from the DCI by: determining a bitwidth for the first SRS resource indicator based on the maximum number of layers supported for the uplink transmission, a third number of layers associated with the second SRS resource indicator and the number of SRS resources in the first set of SRS resources; or determining a bitwidth for the first SRS resource indicator based on the maximum number of layers supported for the uplink transmission over the first set of antenna ports and the number of SRS resources in the first set of SRS resources. In some embodiments, the third number of layers is equal to the second number of layers or a first predetermined value.

In some embodiments, the circuitry may be further configured to: determine the second SRS resource indicator from the DCI by: determining a bitwidth for the second SRS resource indicator based on the maximum number of layers supported for the uplink transmission, a fourth number of layers associated with the first SRS resource indicator and the number of SRS resources in the second set of SRS resources; determining a bitwidth for the second SRS resource indicator based on the maximum number of layers supported for the uplink transmission, the fourth number of layers associated with the first SRS resource indicator, the maximum number of layers supported for the uplink transmission over the second set of antenna ports and the number of SRS resources in the second set of SRS resources; or determining a second bitwidth for the second SRS resource indicator based on the maximum number of layers supported for the uplink transmission over the second set of antenna ports and the number of SRS resources in the second set of SRS resources. In some embodiments, the fourth number of layers is equal to the first number of layers or a second predetermined value.

In some embodiments, the circuitry may be further configured to: receive an indication indicating that the uplink transmission is a CJT transmission or a NCJT transmission.

In some embodiments, the circuitry may be further configured to: transmit at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel; and the uplink transmission is a NCB-based PUSCH and performed via a plurality of TRPs.

In some embodiments, a terminal device deployed with first and second sets of antenna ports comprises a circuitry configured to: receive DCI for scheduling an uplink transmission, the DCI comprising a SRS resource indicator; determine a set of antenna port indexes based on a number of layers of the uplink transmission, indexes of SRS resources in a first set of SRS resources and the number of SRS resources in the first set of SRS resources, the number of layers being indicated by the SRS resource indicator and being transmitted over each of the first and second sets of antenna ports; and performs the uplink transmission over a set of antenna ports corresponding to the set of antenna port indexes in the first and second sets of antenna ports.

In some embodiments, the circuitry may be further configured to: receive a SRS configuration indicating the first set of SRS resources and a second set of SRS resources, wherein SRS resources in the first set of SRS resources are allowed to be used for simultaneous transmission, and the first and second sets of SRS resources are not allowed to be used for simultaneous transmission.

In some embodiments, the circuitry may be further configured to: determine the SRS resource indicator from the DCI by: determining a bitwidth for the SRS resource indicator based on the maximum number of layers supported for the uplink transmission and a half of the number of SRS resources in the first set of SRS resources.

In some embodiments, the circuitry may be further configured to: receive an indication indicating that the uplink transmission is a SDM repetition.

In some embodiments, the circuitry may be further configured to: transmit at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel; and the uplink transmission is a NCB-based PUSCH and performed via a plurality of TRPs.

In some embodiments, a terminal device deployed with first and second sets of antenna ports comprises a circuitry configured to: determine a default capability value set, the default capability value set being associated with a BWP configured for the terminal device; and perform at least one of the following: performing an initial transmission with a network device by applying the default capability value set; or in accordance with a determination that a fallback condition is satisfied, performing an uplink transmission by applying the default capability value set.

In some embodiments, a network device comprises a circuitry configured to: transmit, to a terminal device deployed with first and second sets of antenna ports, DCI for scheduling an uplink transmission, the DCI comprising a first SRS resource indicator and a second SRS resource indicator; determine a first set of antenna port indexes based on a first number of layers of the uplink transmission and indexes of SRS resources in a first set of SRS resources, the first number of layers being indicated by the first SRS resource indicator and being transmitted over the first set of antenna ports; determine a second set of antenna port indexes based on indexes of SRS resources in a second set of SRS resources, a second number of layers of the uplink transmission and the number of SRS resources in the first set of SRS resources, the second number of layers being indicated by the second SRS resource indicator and being transmitted over the second set of antenna ports; and perform the uplink transmission over antenna ports corresponding to the first and second sets of antenna port indexes in the first and second sets of antenna ports.

In some embodiments, the circuitry may be further configured to: transmit a SRS configuration indicating the first set of SRS resources and the second set of SRS resources, wherein SRS resources in the first and second sets of SRS resources are allowed to be used for simultaneous transmission, and the first and second sets of SRS resources are configured with the same time-domain configuration and the same uplink beam configuration.

In some embodiments, the circuitry may be further configured to: determine the first SRS resource indicator by: determining a bitwidth for the first SRS resource indicator based on the maximum number of layers supported for the uplink transmission, a third number of layers associated with the second SRS resource indicator and the number of SRS resources in the first set of SRS resources; or determining a bitwidth for the first SRS resource indicator based on the maximum number of layers supported for the uplink transmission over the first set of antenna ports and the number of SRS resources in the first set of SRS resources. In some embodiments, the third number of layers is equal to the second number of layers or a first predetermined value.

In some embodiments, the circuitry may be further configured to: determine the second SRS resource indicator by: determining a bitwidth for the second SRS resource indicator based on the maximum number of layers supported for the uplink transmission, a fourth number of layers associated with the first SRS resource indicator and the number of SRS resources in the second set of SRS resources; determining a bitwidth for the second SRS resource indicator based on the maximum number of layers supported for the uplink transmission, the fourth number of layers associated with the first SRS resource indicator, the maximum number of layers supported for the uplink transmission over the second set of antenna ports and the number of SRS resources in the second set of SRS resources; or determining a second bitwidth for the second SRS resource indicator based on the maximum number of layers supported for the uplink transmission over the second set of antenna ports and the number of SRS resources in the second set of SRS resources. In some embodiments, the fourth number of layers is equal to the first number of layers or a second predetermined value.

In some embodiments, the circuitry may be further configured to: transmit an indication indicating that the uplink transmission is a CJT transmission or a NCJT transmission.

In some embodiments, a network device comprises a circuitry configured to: transmit, to a terminal device deployed with first and second sets of antenna ports, DCI for scheduling an uplink transmission, the DCI comprising a SRS resource indicator; determine a set of antenna port indexes based on a number of layers of the uplink transmission, indexes of SRS resources in a first set of SRS resources and the number of SRS resources in the first set of SRS resources, the number of layers being indicated by the SRS resource indicator and being transmitted over each of the first and second sets of antenna ports; and perform the uplink transmission over a set of antenna ports corresponding to the set of antenna port indexes in the first and second sets of antenna ports.

In some embodiments, the circuitry may be further configured to: transmit a SRS configuration indicating the first set of SRS resources and a second set of SRS resources, wherein SRS resources in the first set of SRS resources are allowed to be used for simultaneous transmission, and the first and second sets of SRS resources are not allowed to be used for simultaneous transmission.

In some embodiments, the circuitry may be further configured to: determine the SRS resource indicator by: determining a bitwidth for the SRS resource indicator based on the maximum number of layers supported for the uplink transmission and a half of the number of SRS resources in the first set of SRS resources.

In some embodiments, the circuitry may be further configured to: transmit an indication indicating that the uplink transmission is a SDM repetition.

In some embodiments, the circuitry may be further configured to: receive at least one of the following: a first set of capability values of the terminal device associated with the first set of antenna ports, a second set of capability values of the terminal device associated with the second set of antenna ports, or a third set of capability values of the terminal device associated with the first and second sets of antenna ports.

In some embodiments, the first set of antenna ports corresponds to a first panel, and the second set of antenna ports corresponds a second panel, and the uplink transmission is a NCB-based PUSCH and performed via a plurality of TRPs.

In some embodiments, a network device comprises a circuitry configured to: determine a default capability value set for a terminal device, the default capability value set being associated with a BWP configured for the terminal device; and perform at least one of the following: performing an initial transmission with the terminal device by applying the default capability value set; or in accordance with a determination that a fallback condition is satisfied, performing an uplink transmission by applying the default capability value set.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A method, performed by a terminal device with multiple panels, the method comprising:
receiving downlink control information (DCI) comprising a first sounding reference signal (SRS) resource indicator associated with a first SRS resource set and a second SRS resource indicator associated with a second SRS resource set; and
transmitting, to a network device, an uplink transmission based on the DCI,
wherein:
in a case where the uplink transmission is configured in a first multiple panel simultaneous transmission scheme,
a bit width for the first SRS resource indicator is determined based on a number of SRS resources in the first SRS resource set and a maximum number of layers for the first multiple panel simultaneous transmission scheme for the uplink transmission,
a bit width for the second SRS resource indicator is determined based on a number of SRS resources in the second SRS resource set and the maximum number of layers for the first multiple panel simultaneous transmission scheme for the uplink transmission, and
the maximum number of layers for the first multiple panel simultaneous transmission scheme is for each panel of the multiple panels; and
in a case where the uplink transmission is configured in a second multiple panel simultaneous transmission scheme,
the bit width for the first SRS resource indicator is determined based on the number of SRS resources in the first SRS resource set and a maximum number of layers for the second multiple panel simultaneous transmission scheme for the uplink transmission,
the bit width for the second SRS resource indicator is determined based on the number of SRS resources in the second SRS resource set and the maximum number of layers for the second multiple panel simultaneous transmission scheme for the uplink transmission, and
a number of layers corresponding to the second SRS resource indicator is with a same number of layers indicated by the first SRS resource indicator.

32. The method of claim 31, wherein in a case where the uplink transmission is configured in the first multiple panel simultaneous transmission scheme, the bit width for the first SRS resource indicator is determined by:
$${B}_{1} = Ceil ( log 2 ( {\sum }_{k = 1}^{min ( {L}_{max , 1} , {N}_{SRS , 1} )} ( \begin{matrix}{N}_{SRS , 1} \\ k\end{matrix} ) ) )$$
where B₁ denotes the bit width for the first SRS resource indicator, N_{SRS,1} denotes the number of SRS resources in the first SRS resource set, and L_{max,1} is determined by the maximum number of layers of each panel for the uplink transmission.

33. The method of claim 31, wherein in a case where the uplink transmission is configured as the first multiple panel simultaneous transmission scheme, the bit width for the second SRS resource indicator is determined by:
$${B}_{2} = Ceil ( log 2 ( {\sum }_{k = 1}^{min ( {L}_{max , 1} , {N}_{SRS , 2} )} ( \begin{matrix}{N}_{SRS , 2} \\ k\end{matrix} ) ) )$$
where B₂ denotes the bit width for the second SRS resource indicator, N_{SRS,2} denotes the number of SRS resources in the second set of SRS resources, and L_{max,1} is determined by the maximum number of layers for the first multiple panel simultaneous transmission scheme for the uplink transmission.

34. The method of claim 31, wherein
the number of SRS resources in the first SRS resource set is equal to the number of SRS resources in the second SRS resource set.

35. The method of claim 31, wherein
the uplink transmission is configured in the first multiple panel simultaneous transmission scheme or the second multiple panel simultaneous transmission scheme by a radio resource control (RRC) configuration.

36. The method of claim 31, wherein
an SRS resource indicated by the first SRS source indicator and an SRS resource indicated by the second SRS resource indicator are corresponding to different antenna ports.

37. The method of claim 31, wherein
the first SRS resource set and the second SRS resource set are configured with a parameter of usage set to non-codebook.

38. The method of claim 31, wherein
in the case where the uplink transmission is configured in the first multiple panel simultaneous transmission scheme,
a layer set {0 . . . v1−1} is associated with a first resource set corresponding to the first SRS resource indicator, and a layer set {v1 . . . v1+v2−1} is associated with a second resource set corresponding to the second SRS resource indicator, wherein v1 is a number of layers indicated by the first SRS resource indicator, and v2 is a number of layers indicated by the second SRS resource indicator.

39. The method of claim 31, wherein
in the case where the uplink transmission is configured in the second multiple panel simultaneous transmission scheme,
a layer set {0 . . . v} is associated with the a first resource set corresponding to the first SRS resource indicator, and the layer set {0 . . . v} is associated with a second resource set corresponding to the second SRS resource indicator, wherein v is a number of layers of the uplink transmission corresponding to the first SRS resource indicator and the second SRS resource indicator respectively.

40. A method, performed by a network device, the method comprising:
transmitting downlink control information (DCI) comprising a first sounding reference signal (SRS) resource indicator associated with a first SRS resource set and a second SRS resource indicator associated with a second SRS resource set; and
receiving, from a terminal device with multiple panels, an uplink transmission based on the DCI,
wherein:
in a case where the uplink transmission is configured in a first multiple panel simultaneous transmission scheme,
a bit width for the first SRS resource indicator is determined based on a number of SRS resources in the first SRS resource set and a maximum number of layers for the first multiple panel simultaneous transmission scheme for the uplink transmission,
a bit width for the second SRS resource indicator is determined based on a number of SRS resources in the second SRS resource set and the maximum number of layers for the first multiple panel simultaneous transmission scheme for the uplink transmission, and
the maximum number of layers for the first multiple panel simultaneous transmission scheme is for each panel of the multiple panels; and
in a case where the uplink transmission is configured in a second multiple panel simultaneous transmission scheme,
the bit width for the first SRS resource indicator is determined based on the number of SRS resources in the first SRS resource set and a maximum number of layers for the second multiple panel simultaneous transmission scheme for the uplink transmission,
the bit width for the second SRS resource indicator is determined based on the number of SRS resources in the second SRS resource set and the maximum number of layers for the second multiple panel simultaneous transmission scheme for the uplink transmission, and
a number of layers corresponding to the second SRS resource indicator is with a same number of layers indicated by the first SRS resource indicator.

41. The method of claim 40, wherein in a case where the uplink transmission is configured in the first multiple panel simultaneous transmission scheme, the bit width for the first SRS resource indicator is determined by:
$${B}_{1} = Ceil ( log 2 ( {\sum }_{k = 1}^{min ( {L}_{max , 1} , {N}_{SRS , 1} )} ( \begin{matrix}{N}_{SRS , 1} \\ k\end{matrix} ) ) )$$
where B₁ denotes the bit width for the first SRS resource indicator, N_{SRS,1} denotes the number of SRS resources in the first SRS resource set, and L_{max,1} is determined by the maximum number of layers of each panel for the uplink transmission.

42. The method of claim 40, wherein in a case where the uplink transmission is configured as the first multiple panel simultaneous transmission scheme, the bit width for the second SRS resource indicator is determined by:
$${B}_{2} = Ceil ( log 2 ( {\sum }_{k = 1}^{min ( {L}_{max , 1} , {N}_{SRS , 2} )} ( \begin{matrix}{N}_{SRS , 2} \\ k\end{matrix} ) ) )$$
where B₂ denotes the bit width for the second SRS resource indicator, N_{SRS,2} denotes the number of SRS resources in the second set of SRS resources, and L_{max,1} is determined by the maximum number of layers for the first multiple panel simultaneous transmission scheme for the uplink transmission.

43. The method of claim 40, wherein
the number of SRS resources in the first SRS resource set is equal to the number of SRS resources in the second SRS resource set.

44. The method of claim 40, wherein
the uplink transmission is configured in the first multiple panel simultaneous transmission scheme or the second multiple panel simultaneous transmission scheme by a radio resource control (RRC) configuration.

45. The method of claim 40, wherein
an SRS resource indicated by the first SRS source indicator and an SRS resource indicated by the second SRS resource indicator are corresponding to different antenna ports.

46. The method of claim 40, wherein
the first SRS resource set and the second SRS resource set are configured with a parameter of usage set to non-codebook.

47. The method of claim 40, wherein
in the case where the uplink transmission is configured in the first multiple panel simultaneous transmission scheme,
a layer set {0 . . . v1−1} is associated with a first resource set corresponding to the first SRS resource indicator, and a layer set {v1 . . . v1+v2−1} is associated with a second resource set corresponding to the second SRS resource indicator, wherein v1 is a number of layers indicated by the first SRS resource indicator, and v2 is a number of layers indicated by the second SRS resource indicator.

48. The method of claim 40, wherein
in the case where the uplink transmission is configured in the second multiple panel simultaneous transmission scheme,
a layer set {0 . . . v} is associated with the a first resource set corresponding to the first SRS resource indicator, and the layer set {0 . . . v} is associated with a second resource set corresponding to the second SRS resource indicator, wherein v is a number of layers of the uplink transmission corresponding to the first SRS resource indicator and the second SRS resource indicator respectively.

49. A terminal device with multiple panels, comprising a processor configured to cause the terminal device to:
receive downlink control information (DCI) comprising a first sounding reference signal (SRS) resource indicator associated with a first SRS resource set and a second SRS resource indicator associated with a second SRS resource set; and
transmit, to a network device, an uplink transmission based on the DCI,
wherein:
in a case where the uplink transmission is configured in a first multiple panel simultaneous transmission scheme,
a bit width for the first SRS resource indicator is determined based on a number of SRS resources in the first SRS resource set and a maximum number of layers for the first multiple panel simultaneous transmission scheme for the uplink transmission,
a bit width for the second SRS resource indicator is determined based on a number of SRS resources in the second SRS resource set and the maximum number of layers for the first multiple panel simultaneous transmission scheme for the uplink transmission, and
the maximum number of layers for the first multiple panel simultaneous transmission scheme is for each panel of the multiple panels; and
in a case where the uplink transmission is configured in a second multiple panel simultaneous transmission scheme,
the bit width for the first SRS resource indicator is determined based on the number of SRS resources in the first SRS resource set and a maximum number of layers for the second multiple panel simultaneous transmission scheme for the uplink transmission,
the bit width for the second SRS resource indicator is determined based on the number of SRS resources in the second SRS resource set and the maximum number of layers for the second multiple panel simultaneous transmission scheme for the uplink transmission, and
a number of layers corresponding to the second SRS resource indicator is with a same number of layers indicated by the first SRS resource indicator.

50. The terminal device of claim 49, wherein
the first SRS resource set and the second SRS resource set are configured with a parameter of usage set to non-codebook.
